(19) United States
(12) Patent Application Publication
(10) Pub. No.: US 2026/0177960 A1
(43) Pub. Date: Jun. 25, 2026

(54) IMAGE FORMING APPARATUS

(71) Applicant: CANON KABUSHIKI KAISHA, Tokyo (JP)

(72) Inventors: SHINKICHI YAMAMOTO, Shizuoka (JP); HIROSHI KAWAMURA, Shizuoka (JP)

(21) Appl. No.: 19/422,623

(22) Filed: Dec. 17, 2025

(30) Foreign Application Priority Data
Dec. 19, 2024 (JP) 2024-224518
Oct. 2, 2025 (JP) 2025-166441

(51) Int. Cl. G03G 15/00; G03G 15/16

(52) U.S. Cl. CPC G03G 15/5008; G03G 15/1615

(57) ABSTRACT

An image forming apparatus includes: a first transmission member; a second transmission member; a third transmission member configured to engage with the first transmission member and being apart from the second transmission member; a fourth transmission member configured to engage with the second transmission member and being apart from the first transmission member; a biasing member that is connected to the third transmission member and the fourth transmission member, and biases one of the third transmission member and the fourth transmission member in the first rotation direction and biases the other of the third transmission member and the fourth transmission member in a second rotation direction; and a connection portion that is connected to the first transmission member and the second transmission member to form a drive train including the first transmission member, the second transmission member, the third transmission member, the biasing member, and the fourth transmission member.

### BACKGROUND

### Field of the Technology

The present disclosure relates to an image forming apparatus such as a copying machine, a printer, or a facsimile that includes a mechanism that drives a rotating member.

### Description of the Related Art

It is known that, when a driving force is transmitted to a rotating member via a load body such as a flywheel or a friction wheel, rotation of a rotating member is accurately kept (Japanese Patent Application Publication No. 2002-156020).

If a drive train that transmits a driving force by engaging a plurality of transmission members is formed, and a backlash is present at engagement portions of the transmission members, a rotation speed may fluctuate in the drive train.

### SUMMARY

The present disclosure is directed to provide a configuration that can suppress fluctuations of a rotation speed in a drive train.

In order to solve the above problem, an image forming apparatus according to the present disclosure includes:

a first transmission member;

a second transmission member;

a third transmission member configured to rotate about a rotation axis in a first rotation direction, the third transmission member configured to engage with the first transmission member and being apart from the second transmission member;

a fourth transmission member configured to rotate about the rotation axis in the first rotation direction, the fourth transmission member configured to engage with the second transmission member and being apart from the first transmission member;

a biasing member connected to the third transmission member and the fourth transmission member, and the biasing member configured to bias one of the third transmission member and the fourth transmission member in the first rotation direction and to bias an other of the third transmission member and the fourth transmission member in a second rotation direction opposite to the first rotation direction; and

a connection portion that is connected to the first transmission member and the second transmission member to form a drive train forming a closed loop, the closed loop including the first transmission member, the second transmission member, the third transmission member, the biasing member, and the fourth transmission member, wherein

a rotational speed of the third transmission member is the same as a rotational speed of the fourth transmission member.

Features of the present disclosure will become apparent from the following description of embodiments with reference to the attached drawings. The following description of embodiments is described by way of example.

### BRIEF DESCRIPTION OF THE DRAWINGS

FIG. 1 is a cross-sectional view of an image forming apparatus.

FIG. 2A is a perspective view illustrating a drive train according to Embodiment 1.

FIG. 2B is a part diagram illustrating the inside of a driving stabilization unit in FIG. 2A.

FIG. 3A is an enlarged view illustrating a meshing state of gears in the drive train, and a portion E in FIG. 2A.

FIG. 3B is an enlarged view illustrating a meshing state of the gears in the drive train, and a portion F in FIG. 2A.

FIG. 3C is an enlarged view illustrating a meshing state of a drum gear and an idler stepped gear.

FIG. 3D is an enlarged view illustrating the meshing state of the drum gear and the idler stepped gear.

FIG. 4A is a perspective view of a drum drive portion according to Embodiment 2.

FIG. 4B is a view of the driving stabilization unit according to Embodiment 2.

FIG. 5A is a schematic view illustrating a drive train according to Embodiment 2.

FIG. 5B is a diagram illustrating a rotation direction of each gear and a direction of a torque received by each gear in the drive train according to Embodiment 2.

FIG. 6A is a schematic view illustrating the drive train according to Embodiment 2.

FIG. 6B is a schematic view illustrating another example of the drive train according to Embodiment 2.

FIG. 7 is a cross-sectional view of an image forming apparatus according to Embodiment 3.

FIG. 8A is a perspective view of the drum drive portion according to Embodiment 3.

FIG. 8B is a part diagram illustrating the inside of the driving stabilization unit in FIG. 8A.

FIG. 9A is a perspective view of the drum drive portion according to a modified example.

FIG. 9B is a part diagram illustrating the inside of a driving stabilization unit in FIG. 9A.

FIG. 10A is a diagram illustrating a drive train including the driving stabilization unit according to Embodiment 4.

FIG. 10B is a perspective view and an exploded view of the driving stabilization unit according to Embodiment 4.

FIG. 11A is a diagram illustrating an operation of the drive train according to Embodiment 4, and is a diagram illustrating a state where a releasing cam is apart from a first adjustment gear.

FIG. 11B is a diagram illustrating the operation of the drive train according to Embodiment 4, and is a diagram illustrating a state where the releasing cam has rotated from a position in FIG. 11A.

FIG. 11C is a diagram illustrating the operation of the drive train according to Embodiment 4 and is a diagram illustrating a retracting operation of the releasing cam.

FIG. 11D is a diagram illustrating the operation of the drive train according to Embodiment 4 and is a diagram illustrating a state where the releasing cam has retracted.

FIG. 12A is a diagram illustrating the drive train including the driving stabilization unit according to Embodiment 5.

FIG. 12B is a perspective view of the driving stabilization unit according to Embodiment 5.

FIG. 12C is an exploded view of the driving stabilization unit according to Embodiment 5.

FIG. 13A is a diagram illustrating operations of a pinion gear, the driving stabilization unit, and drum gears in the drive train at a time at which a motor rotates forward according to Embodiment 5.

FIG. 13B is an enlarged view of the driving stabilization unit and the drum gears at a time at which the motor rotates forward according to Embodiment 5.

FIG. 13C is a perspective view of the driving stabilization unit at the time at which the motor rotates forward according to Embodiment 5.

FIG. 13D is a perspective view of the driving stabilization unit at the time at which the motor rotates forward according to Embodiment 5.

FIG. 14A illustrates an operation of a force applying cam in the drive train at a time at which the motor rotates backward according to Embodiment 5.

FIG. 14B is a diagram illustrating the operation of the force applying cam in the drive train at the time at which the motor rotates backward according to Embodiment 5.

FIG. 14C is a diagram illustrating the operation of the force applying cam in the drive train at the time at which the motor rotates backward according to Embodiment 5.

### DESCRIPTION OF THE EMBODIMENTS

Hereinafter, embodiments of the present disclosure will be described in detail based on embodiments with reference to the drawings. In this regard, the dimensions, materials, shapes, relative arrangements, and the like of the components described in the embodiments may be appropriately modified according to the configurations and various conditions of apparatuses to which the present disclosure is applied. That is, the scope of the present disclosure is not intended to be limited to the embodiments described below. Furthermore, while a plurality of features is described in the embodiments, all of the plurality of features are not necessarily essential to the disclosure, and the plurality of features may be combined with each other in any way. Moreover, in the accompanying drawings, the same reference numeral will be assigned to the same or similar component and overlapping description will be omitted.

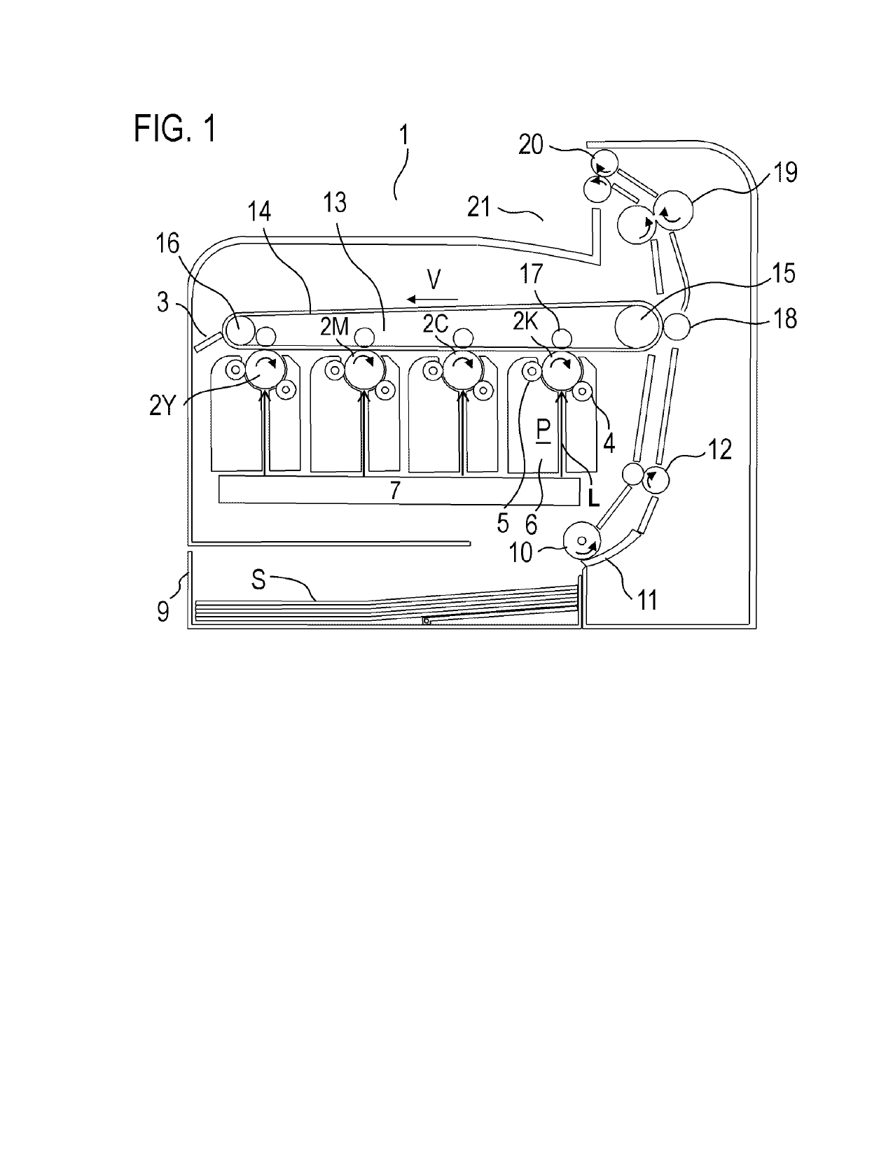

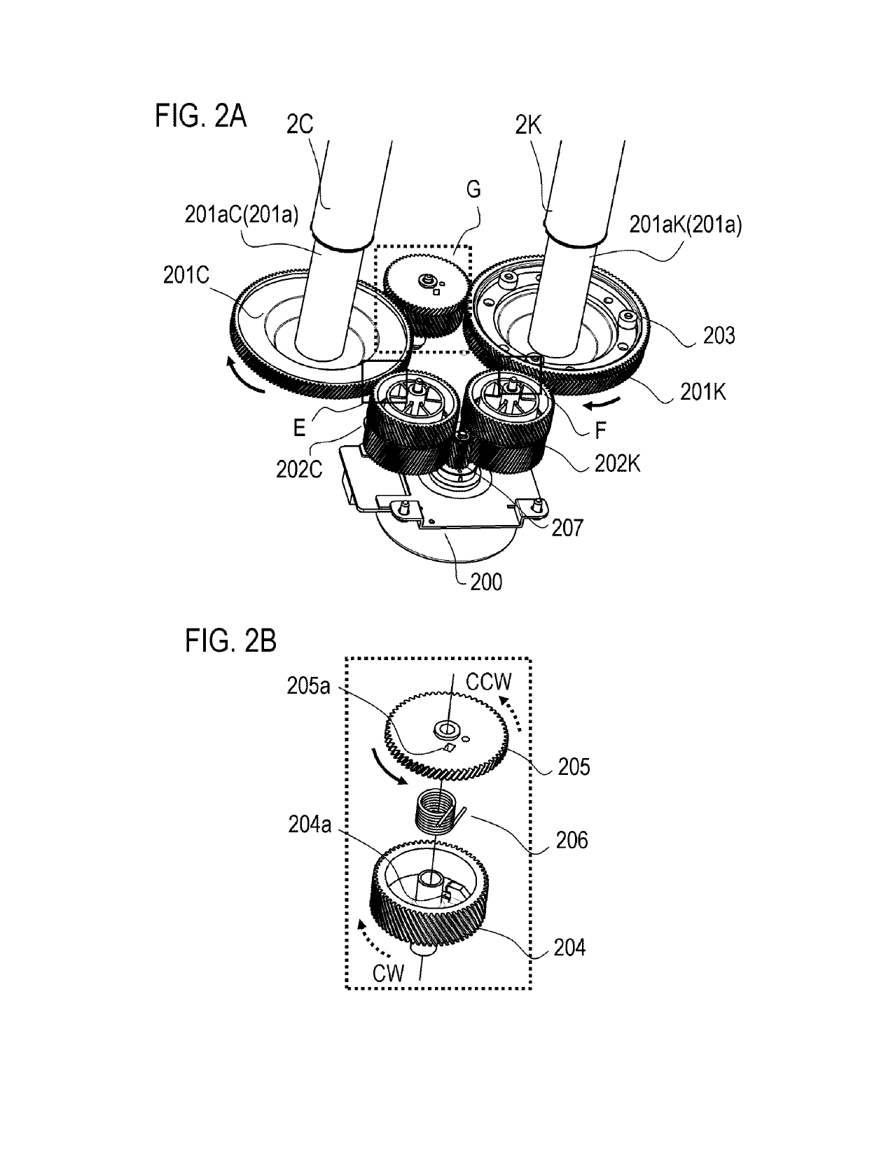

As for an order of description, an overall schematic configuration and an image forming process of an image forming apparatus that are common between Embodiment 1 and Embodiment 2 will be described first with reference to FIG. 1. Next, a drive configuration of a photosensitive drum will be described in detail with reference to FIGS. 2A and 2B.

### Overall Schematic Configuration of Image Forming Apparatus

FIG. 1 is a cross-sectional view of an image forming apparatus 1. The image forming apparatus 1 is a four-color full-color laser beam printer that uses an electrophotographic process and forms a color image on a recording material S. This image forming apparatus 1 includes photosensitive drums (2K (black), 2C (cyan), 2M (magenta), and 2Y (yellow)) as image bearing members that bear electrostatic latent images. Since the photosensitive drums 2K, 2C, 2M and 2Y employ a common configuration, the letters Y, M, C, and K indicating the respective colors may be omitted in the following description. The image forming apparatus 1 includes charging members (charging rollers) 4 that charge photosensitive drums 2. Furthermore, the image forming apparatus 1 includes developing units that each include a developing member (developing roller) 5 that develops an electrostatic latent image formed on the photosensitive drum 2, and a toner container 6 that contains a developer (toner) supplied to the developing roller 5. A charging roller 4 and the developing unit are included in each photosensitive drum 2 (2K, 2C, 2M, and 2Y). The image forming apparatus 1 includes cartridges P that are detachable from an apparatus main body. Although the cartridge P includes the developing unit in the present embodiment, the cartridge P may further include the photosensitive drum 2 and the charging roller 4.

Below the respective cartridges P, a laser scanner 7 is installed as an exposing device for the respective photosensitive drums 2 (2K, 2C, 2M, and 2Y). Furthermore, below this laser scanner 7, a feeding unit that feeds the recording materials S (generally, paper) to the image forming portion is installed. This feeding unit includes a sheet feeding cassette 9 in which the recording materials S are loaded and contained, a sheet feeding roller 10, and a separation portion 11. Furthermore, the image forming apparatus 1 includes a pair of resist rollers 12.

An intermediate transfer unit 13 is installed above the respective photosensitive drums 2. This intermediate transfer unit 13 includes an intermediate transfer belt (hereinafter referred to as a transfer belt) 14 to which toner images formed on the photosensitive drums 2 are primarily transferred. The transfer belt 14 is supported by a driver roller 15 and a tension roller 16.

Each photosensitive drum 2 (2K, 2C, 2M, and 2Y) is in contact with the lower surface of the transfer belt 14. A contact portion between each photosensitive drum 2 and the transfer belt 14 is a primary transfer portion. Primary transfer rollers 17 are installed on the inner side of the transfer belt 14 and at positions meeting the photosensitive drums 2. The transfer belt 14 is circulated and moved in an arrow V direction by the driver roller 15 in a state where the transfer belt 14 is in contact with all of the photosensitive drums 2. A surface speed of the transfer belt 14 is higher than surface speeds of the photosensitive drums 2. In the present embodiment, the surface speed of the transfer belt 14 is a speed that exceeds 100% of and is less than 110% of the surface speeds of the photosensitive drums 2. Note that, by setting the speed of the transfer belt 14 to a higher speed than those of the photosensitive drums 2, it is possible to increase the toner transfer efficiency, and reduce untransferred toner remaining on the surfaces of the photosensitive drums 2. A predetermined primary transfer voltage is applied to the primary transfer rollers 17.

Furthermore, a secondary transfer roller 18 is in contact with the transfer belt 14. The transfer belt 14 is sandwiched between the driver roller 15 and the secondary transfer roller 18. A contact portion between the secondary transfer roller 18 and the transfer belt 14 is a secondary transfer portion. A predetermined secondary transfer voltage is applied to the secondary transfer roller 18. A cleaning blade 3 that removes toner on the transfer belt 14 is in contact with the transfer belt 14. The secondary transfer roller 18, each primary transfer roller 17, and the tension roller 16 are driven by the transfer belt 14. A torque necessary for the driver roller 15 to rotate is greater than a torque necessary for each photosensitive drum 2 to rotate.

A pair of fixing rollers 19 and a pair of discharge rollers 20 are installed at an upper portion in the image forming apparatus 1. The upper surface of the image forming apparatus 1 is a discharge tray 21.

### Image Forming Process

Next, the image forming process of the image forming apparatus will be described with reference to FIG. 1.

Each photosensitive drum 2 is driven in a direction indicated by an arrow direction in FIG. 1 at a predetermined rotation speed. The charging roller 4 uniformly charges the surface of the photosensitive drum 2 that rotates. The laser scanner 7 emits a laser beam L corresponding to image information to the photosensitive drum 2. Thus, an electrostatic latent image corresponding to the image information is formed on the surface of the photosensitive drum 2. This electrostatic latent image is developed as a toner image (developer image) with toner (developer) supplied by the developing roller 5.

Furthermore, the toner image born on the photosensitive drum 2 is then transferred onto the transfer belt 14 at the primary transfer portion by the primary transfer roller 17. In the present embodiment, toner remaining on the photosensitive drum 2 without being transferred onto the transfer belt 14 is collected by the developing roller 5. The toner image transferred onto the transfer belt 14 is conveyed to the secondary transfer portion as the transfer belt 14 rotates. On the other hand, the recording material S fed from the feeding unit is conveyed to the secondary transfer portion by the pair of resist rollers 12. The toner image transferred onto the transfer belt 14 is transferred onto the recording material S at the secondary transfer portion. The recording material S onto which the toner image has been transferred is conveyed to the pair of fixing rollers 19. The toner image on the recording material S is heated and pressurized by this pair of fixing rollers 19, and thereby is fixed onto the recording material S. Thereafter, the recording material S is discharged onto the discharge tray 21 by the pair of discharge rollers 20.

In the above image forming process, since image quality lowers when rotation of the photosensitive drums 2 becomes unstable, the photosensitive drums 2 rotate at a constant speed. The image forming apparatus 1 according to the present embodiment employs a so-called cleanerless configuration where toner remaining on the photosensitive drums 2 is collected by the developing roller 5. Accordingly, as compared with a configuration where the toner remaining on the photosensitive drums 2 is removed by a cleaning member such as a cleaning blade, a torque necessary for the photosensitive drums 2 to rotate is small.

### Embodiment 1

### Drive Configuration

Next, a drum drive portion as a rotating member drive portion will be described in detail. The drum drive portion includes a drive train described below. The drum drive portion according to the present embodiment drives the plurality of photosensitive drums 2 as a plurality of rotating members.

FIGS. 2A and 2B are diagrams illustrating the drive train (driving force transmission route) according to the present embodiment. FIG. 2A is a perspective view of the drive train, and illustrates a transmission route of the driving force from a motor 200 to the photosensitive drum 2K and the photosensitive drum 2C. Furthermore, FIG. 2B is a part diagram illustrating the inside of a driving stabilization unit G in FIG. 2A.

Since the drum drive portion of the photosensitive drum 2M and the photosensitive drum 2Y is the same as the drum drive portion of the photosensitive drum 2K and the photosensitive drum 2C to be described below in Embodiment 1, description thereof will be omitted.

A configuration of the drum drive portion of the photosensitive drum 2K (first photosensitive drum) as the first rotating member and the photosensitive drum 2C (second photosensitive drum) as the second rotating member will be described. The drum drive portion includes the motor 200 as a driving source, a pinion gear 207, a drum gear 201C, a drum gear 201K, idler stepped gears (202C and 202K), and an attachment gear 203. The pinion gear 207 is attached to an output shaft of the motor 200 as an example of an output transmission member. Note that the output shaft of the motor 200 may have a gear shape corresponding to the pinion gear 207.

The motor 200 generates a driving force for driving the photosensitive drums 2. The pinion gear 207 is fixed to the output shaft of the motor 200 by indentation. The drum gear 201C is connected to the photosensitive drum 2C. In the present embodiment, the drum gear 201C includes a coupling portion (first coupling) 201aC (201a) that engages with the photosensitive drum 2C. The drum gear 201C is an example of a first gear (first transmission member) that engages with a first adjustment gear 204 described later. The drum gear 201C rotates the photosensitive drum 2 in an arrow direction in FIG. 2A. The drum gear 201K is connected to the photosensitive drum 2K. In the present embodiment, the drum gear 201K includes a coupling portion (second coupling) 201aK (201a) that engages with the photosensitive drum 2K. The attachment gear 203 is fixed to the drum gear 201K. In other words, the drum gear 201K and the attachment gear 203 are integrated. The member (gear) formed by integrating the drum gear 201K and the attachment gear 203 is an example of a second gear (second transmission member) that engages with a second adjustment gear 205 described later. The idler stepped gear 202C engages with the pinion gear 207 and the drum gear 201C. The idler stepped gear 202K engages with the pinion gear 207 and the drum gear 201K. The coupling portion 201a is configured to engage with the photosensitive drum 2 to transmit the driving force of the motor 200 to the photosensitive drum 2. The coupling portion 201a may detachably engage with the photosensitive drum 2.

The coupling portion 201a is configured to engage with the photosensitive drum 2 to transmit the driving force of the motor 200 to the photosensitive drum 2. The coupling portion 201a detachably engages with the photosensitive drum 2. Note that the respective photosensitive drums (2C and 2K) and the respective drum gears (201C and 201K) may be inseparably integrated.

A configuration of the driving stabilization unit G will be described with reference to FIG. 2B.

The driving stabilization unit G includes the first adjustment gear 204, the second adjustment gear 205, and a torsion coil spring (hereinafter referred to as a spring) 206. The first adjustment gear 204 is an example of a third gear (third transmission member) that meshes (engages) with the drum gear 201C. The second adjustment gear 205 is an example of a fourth gear (fourth transmission member) that meshes (engages) with the attachment gear 203 of the second gear (second transmission member). The first adjustment gear 204 is apart from the second transmission members (the attachment gear 203 and the drum gear 201K) and does not mesh with these second transmission members. The second adjustment gear 205 is apart from the drum gear 201C and does not mesh with the drum gear 201C. The spring 206 is attached to the first adjustment gear 204 and the second adjustment gear 205 to generate a spring force. More specifically, a first arm of the spring 206 is held by a spring hook portion 204a of the first adjustment gear 204, and a second arm of the spring 206 is held by a spring hook portion 205a of the second adjustment gear 205. The spring 206 is a biasing member that biases one of the first adjustment gear 204 and the second adjustment gear 205 toward a direction CCW (first rotation direction), and biases the other of the first adjustment gear 204 and the second adjustment gear 205 in a direction CW (second rotation direction) opposite to the direction CCW (first rotation direction). In the present embodiment, the spring 206 biases the first adjustment gear 204 in the direction CW, and biases the second adjustment gear 205 in the direction CCW. The spring force (biasing force) of the spring 206 is applied from the first adjustment gear 204 to the drum gear 201C in a dotted line arrow direction CW (second rotation direction) in FIG. 2B. The spring force (biasing force) of the spring 206 is applied from the second adjustment gear 205 to the attachment gear 203 in the dotted line arrow direction CCW (first rotation direction) that is an opposite direction to the dotted line arrow direction CW.

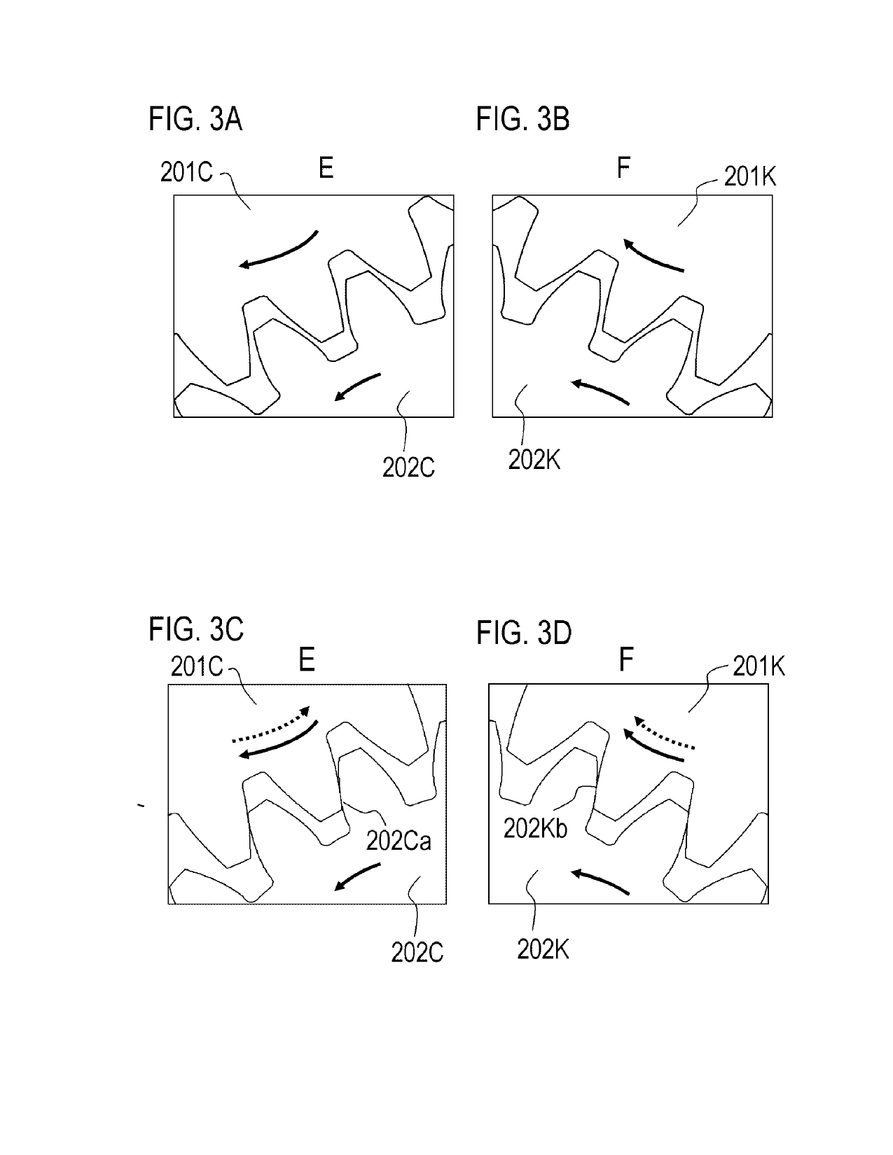

The spring force acting on the first adjustment gear 204 acts to increase a rotation load of the drum gear 201C. On the other hand, the spring force acting on the second adjustment gear 205 acts to reduce the rotation load of the drum gear 201K. Furthermore, the first adjustment gear 204 and the second adjustment gear 205 rotate about a predetermined rotation axis in a solid line arrow direction (first rotation direction) in FIG. 3B at the same rotational speed.

The first adjustment gear 204 and the second adjustment gear 205 are connected by the spring 206 to rotate about a common rotation axis in the same direction at the same rotational speed (a rotational speed per unit time). As a result, a spring pressure of the spring 206 is kept substantially constantly while the first adjustment gear 204 and the second adjustment gear 205 are rotating. The ratio of the rotational speeds (a ratio of rotation speeds) of the first adjustment gear 204 and the drum gear 201C is the same as the ratio of rotational speeds (a ratio of rotation speeds) of the second adjustment gear 205 and the drum gear 201K. In the present embodiment, since the rotational speeds, the numbers of teeth, and modules of the drum gear 201C and the attachment gear 203 are the same, the first adjustment gear 204 and the second adjustment gear 205 include the same number of teeth. At least one of the drum gear 201C and the attachment gear 203 may be a profile shifted gear, and at least one of the first adjustment gear 204 and the second adjustment gear 205 may be a profile shifted gear. Note that, if the first adjustment gear 204 and the second adjustment gear 205 have the same rotational speed, the first adjustment gear 204 and the second adjustment gear 205 may include different numbers of teeth by adjusting the modules.

A driving state of gears during image formation will be described with reference to FIGS. 3A to 3D. FIGS. 3A, 3B, 3C, and FIG. 3D are enlarged views illustrating a meshing state of gears in the drive train. FIGS. 3A and 3C are the enlarged views illustrating the meshing state of the drum gear 201C and the idler stepped gear 202C at a portion E in FIG. 2A. FIGS. 3B and 3D are the enlarged views illustrating the meshing state of the drum gear 201K and the idler stepped gear 202K at a portion F in FIG. 2A.

During image formation, a driving force is transmitted from the motor 200 to each photosensitive drum 2. As described above, the surface speed of the transfer belt 14 is higher than the surface speeds of the photosensitive drums 2. Hence, the photosensitive drums 2 receive a force from the transfer belt 14 in such a direction (leading rotation direction) that the rotation speeds of the photosensitive drums 2 increase. The force in the leading rotation direction received by the photosensitive drum 2 from the transfer belt 14 fluctuates depending on the toner amount on the photosensitive drum 2. When the force received by the photosensitive drum 2 from the transfer belt 14 exceeds the rotation load of the photosensitive drum 2, a phenomenon (leading rotation, overrunning rotation) that the rotation speed of the photosensitive drum 2 becomes faster than the rotation speed of the photosensitive drum 2 by the motor 200 may occur.

If the above-described leading rotation of the photosensitive drum 2 occurs in the absence of the above-described driving stabilization unit G, leading rotation states of the drum gears 201C and 201K occur as illustrated in FIGS. 3A and 3B. That is, the drum gears 201C and 201K move apart from gear tooth surfaces of the idler stepped gears 202C and 202K, respectively, and rotation of the photosensitive drums 2C and 2K is in an unstable state. As a result, image quality (uniformity of image density) may lower.

Next, the driving state of the photosensitive drum 2 in a case where the driving stabilization unit G that is the component of the present disclosure is disposed will be described. First, driving of the photosensitive drum 2C will be described. As illustrated in FIG. 3C, the drum gear 201C receives a spring force in a middle dotted line arrow direction in FIG. 3C from the first adjustment gear 204. The spring force is greater than a force received by the photosensitive drums 2C from the transfer belt 14, and a force (rotation load) necessary for the photosensitive drums 2K to rotate. Hence, the drum gear 201C rotates in contact with a downstream side tooth surface 202Ca of the idler stepped gear 202C without moving apart from the idler stepped gear 202C. The downstream side tooth surface 202Ca of the idler stepped gear 202C is a tooth surface directed to the downstream side in a rotation direction of the idler stepped gear 202C. A relationship between the meshing portions of the idler stepped gear 202C and the pinion gear 207 is the same as a relationship between the meshing portions of the drum gear 201C and the idler stepped gear 202C illustrated in FIG. 3C. That is, the idler stepped gear 202C receives the spring force from the drum gear 201C, and contacts the downstream side tooth surface of the pinion gear 207 (the surface directed to the downstream side in the rotation direction of the pinion gear 207) without moving apart from the pinion gear 207. As a result, even when the photosensitive drum 2C receives a force in the leading rotation direction, contact states of the respective gears are maintained. That is, each gear is kept in a state where each gear rotates according to the speed of the motor 200. As a result, the rotation speed of the photosensitive drum 2C by the motor 200 is kept, and the photosensitive drum 2C can rotate at a constant speed.

Next, the driving state of the photosensitive drum 2K will be described. As illustrated in FIG. 3D, the drum gear 201K receives a spring force in a middle dotted line arrow direction in FIG. 3D from the second adjustment gear 205 via the attachment gear 203. The spring force is greater than the rotation load of the photosensitive drum 2K. Therefore, the drum gear 201K rotates in contact with an upstream side tooth surface 202Kb of the idler stepped gear 202K without moving apart from the idler stepped gear 202K. The upstream side tooth surface 202Kb of the idler stepped gear 202K is a surface directed to the upstream side in the rotation direction of the idler stepped gear 202K. A relationship between meshing portions of the idler stepped gear 202K and the pinion gear 207 is the same as a relationship between meshing portions of the drum gear 201K and the idler stepped gear 202K illustrated in FIG. 3D. That is, the idler stepped gear 202K receives the spring force from the drum gear 201K, and contacts the upstream side tooth surface of the pinion gear 207 (the surface directed to the upstream side in the rotation direction of the pinion gear 207) without moving apart from the pinion gear 207. As a result, even when the photosensitive drum 2K receives a force in the leading rotation direction, contact states of the respective gears are maintained. That is, each gear is kept in a state where each gear rotates according to the speed of the motor 200. As a result, the rotation speed of the photosensitive drum 2K by the motor 200 is kept, and the photosensitive drum 2K can rotate at a constant speed.

As described above, the meshing state of the gears is maintained by the spring 206. Accordingly, even when the magnitude of the force received by the photosensitive drum 2 changes, rotational fluctuation of the photosensitive drum 2 is suppressed. Note that, although the drum gear 201K and the drum gear 201C are connected to the photosensitive drum 2C and the photosensitive drum 2K in the present embodiment, gears corresponding to the idler stepped gear 202C and the idler stepped gear 202K may be connected to the photosensitive drum 2C and the photosensitive drum 2K. That is, in the drive train, gears other than the drum gear 201K and the drum gear 201C in the present embodiment may have components corresponding to the above-mentioned coupling portions.

In the present embodiment, the idler stepped gear 202C, the pinion gear 207, and the idler stepped gear 202K are examples of connection portions (intermediate transmission portions) connected to the drum gear 201C (first transmission member), and the drum gear 201K and the attachment gear 203 (second transmission members). The connection portions are connected to the first transmission member and the second transmission member to form the drive train forming a closed loop including the first transmission member, the second transmission member, and the driving stabilization unit G (the first adjustment gear 204 (third transmission member), the spring 206 (biasing member), and the second adjustment gear 205 (fourth transmission member). The pinion gear 207 is an output transmission member that is driven by the motor 200 as a driving source and is included in the drive train (more specifically, the connection portion). Note that the number of gears included in the connection portion may one or may be plural. Furthermore, although the pinion gear 207 is an example of the output transmission member, the output transmission member may not be directly coupled to the shaft of the motor 200.

Furthermore, the present embodiment may employ a configuration where the first adjustment gear 204 (third transmission member) and the second adjustment gear 205 (fourth transmission member) are coaxially arranged. Furthermore, in the present embodiment, the number of teeth of the drum gear 201C (first transmission member) and the number of teeth of the attachment gear 203 of the second transmission member are the same. Furthermore, the number of teeth of the first adjustment gear 204 that meshes with the drum gear 201C and the number of teeth of the second adjustment gear 205 that meshes with the attachment gear 203 are the same. That is, the first transmission member includes a plurality of first teeth, the second transmission member includes a plurality of second teeth, the third transmission member includes a plurality of third teeth that mesh with a plurality of first teeth, and the fourth transmission member includes a plurality of fourth teeth that mesh with a plurality of second teeth. Furthermore, the number of teeth of the plurality of third teeth and the number of teeth of the plurality of fourth teeth are the same, and the number of teeth of the plurality of first teeth and the number of teeth of the plurality of second teeth are the same.

Note that the spring 206 may bias the first adjustment gear 204 in the direction CCW and bias the second adjustment gear 205 in the direction CW. In this case, the spring force is applied in the direction CCW from the first adjustment gear 204 to the drum gear 201C, and the spring force of the spring 206 is applied in the direction CW from the second adjustment gear 205 to the attachment gear 203. In this case, the drum gear 201C rotates in contact with an upstream side tooth surface of the idler stepped gear 202C (the tooth surface directed to upstream side in the rotation direction of the idler stepped gear 202C) without moving apart from the idler stepped gear 202C. Furthermore, the idler stepped gear 202C contacts the upstream side tooth surface of the pinion gear 207 (the surface directed to upstream side in the rotation direction of the pinion gear 207) without moving apart from the pinion gear 207. The drum gear 201K rotates in contact with the downstream side tooth surface of the idler stepped gear 202K (the tooth surface directed to the downstream side in the rotation direction of the idler stepped gear 202K) without moving apart from the idler stepped gear 202K. Furthermore, the idler stepped gear 202K contacts the downstream tooth surface of the pinion gear 207 (the surface directed to the downstream side in the rotation direction of the pinion gear 207) without moving apart from the pinion gear 207. Even in this case, the meshing state of the respective gears is maintained by the spring 206. Accordingly, even when the magnitude of the force received by the photosensitive drum 2 changes, rotational fluctuation of the photosensitive drum 2 is suppressed.

As described above, it is possible to suppress an unstable state due to leading rotation in the case where rotation loads of the photosensitive drums are little, and constantly maintain the rotation speeds of the photosensitive drums. Accordingly, it is possible to suppress image quality from lowering. Furthermore, the configuration according to the present embodiment can constantly maintain the rotation speeds of the photosensitive drums without adding a flywheel or the like and intentionally increasing the rotation loads of the photosensitive drums. Accordingly, it is possible to easily miniaturize the motor 200 and achieve a lower torque.

### Embodiment 2

Embodiment 2 differs from Embodiment 1 only in a driving component. Hence, only the drive configuration will be described, and portions that overlap those in Embodiment 1 will be omitted.

### Drive Configuration

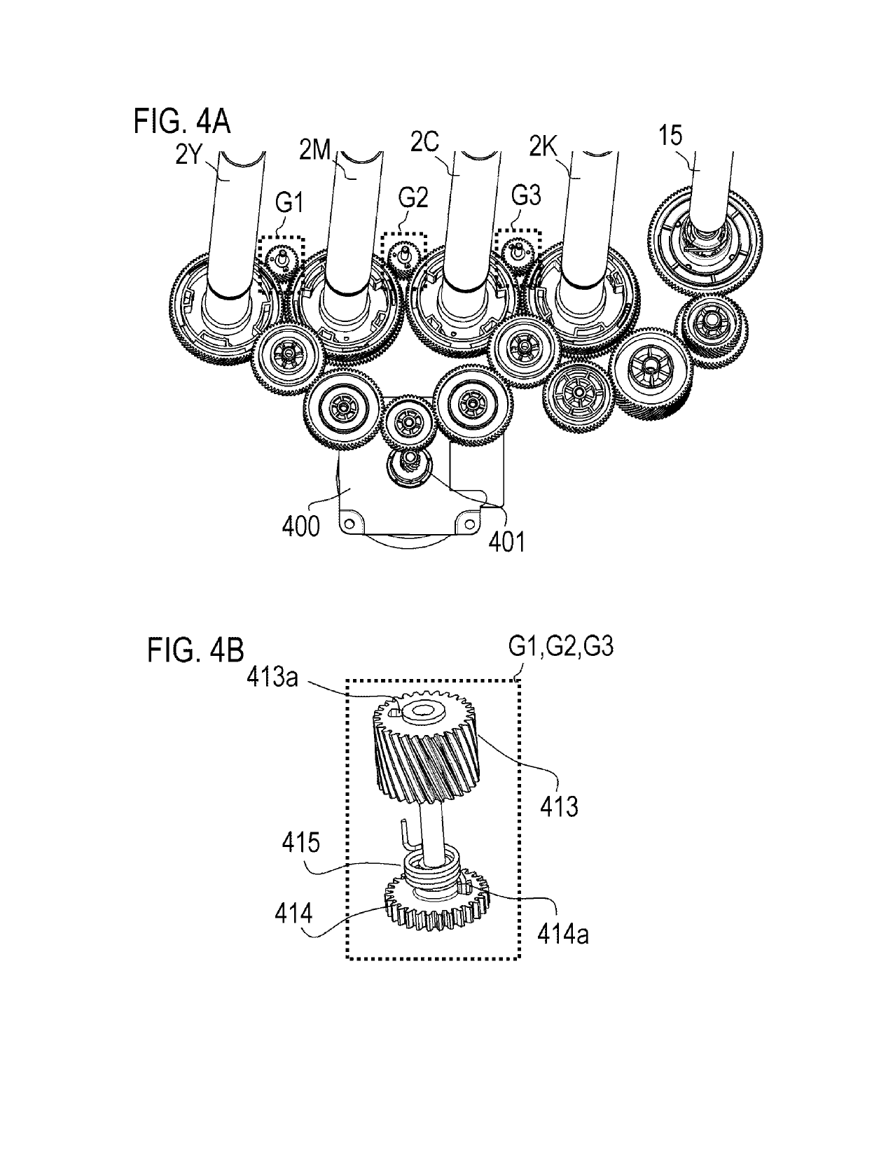

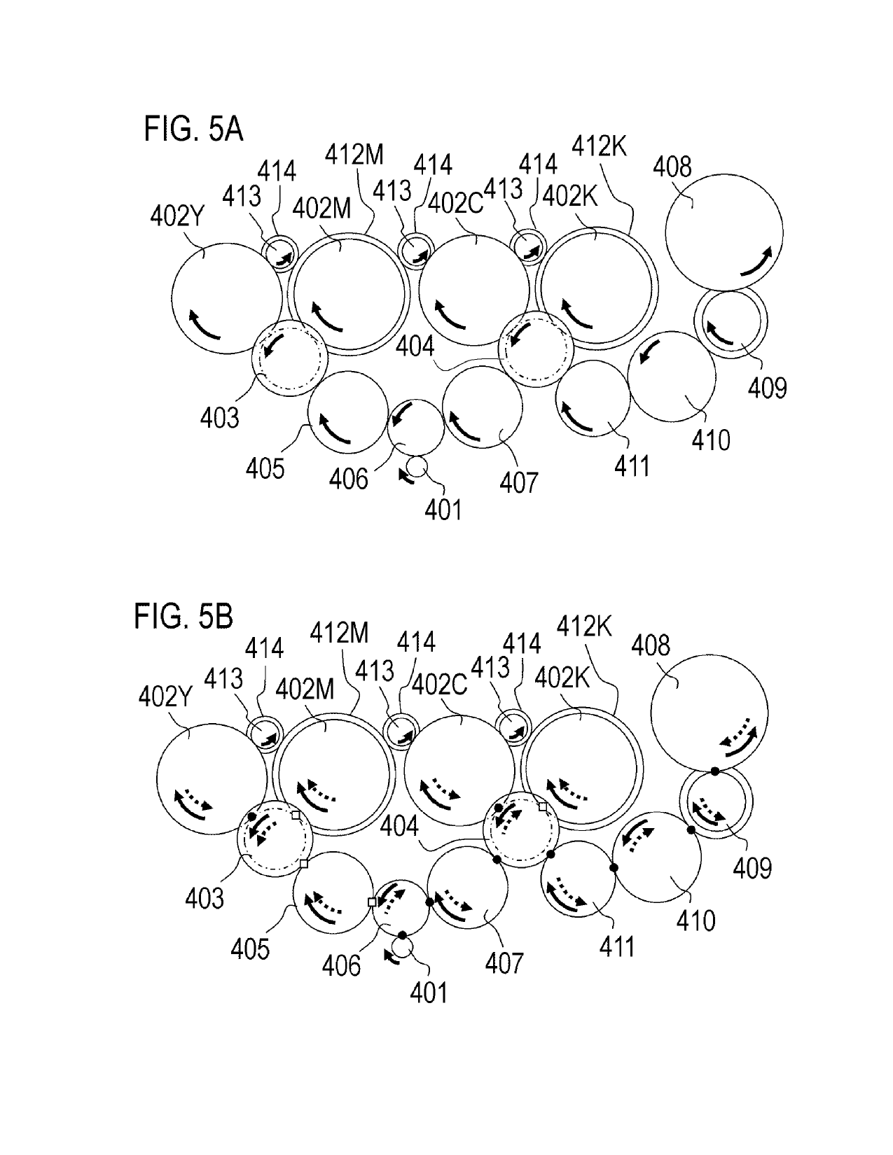

The drum drive portion as the rotating member drive portion according to Embodiment 2 will be described in detail with reference to FIGS. 4A, 4B, and 5A.

FIGS. 4A and 4B are diagrams illustrating the drum drive portion according to the present embodiment. FIG. 4A is a perspective view of the drum drive portion according to Embodiment 2. In Embodiment 2, one motor 400 is configured as a driving source to rotate and drive the four photosensitive drums (2K, 2C, 2M, and 2Y) and the driver roller 15. The present embodiment employs a configuration where leading rotation of each photosensitive drum 2 is prevented by arranging three driving stabilization units (G1, G2, and G3).

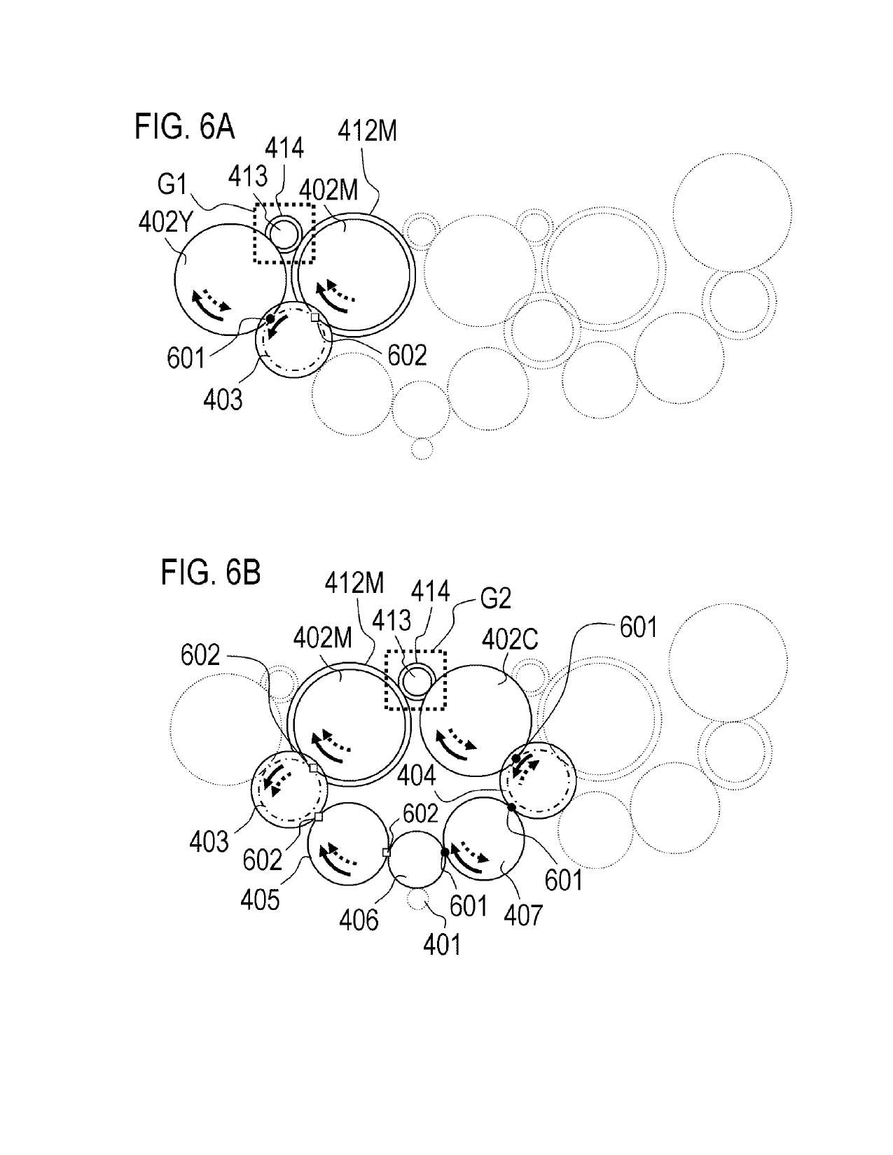

FIGS. 5A, 5B, 6A, and 6B are schematic views illustrating a drive train according to the present embodiment. The drive train according to the present embodiment includes drum gears (402Y, 402M, 402C, and 402K), an idler stepped gear 403, an idler stepped gear 404, idler gears 405, 406, and 407, and attachment gears 412M and 412K. Furthermore, the drive train according to the present embodiment includes the driving stabilization units G1, G2, and G3. The idler gear 406 meshes with a pinion gear 401. The pinion gear 401 is fixed to the shaft of the motor 400 by indentation. The drum gears (402K, 402C, 402M, and 402Y) are connected to the respective photosensitive drums (2K, 2C, 2M, and 2Y), and rotate the photosensitive drums in an arrow direction in FIG. 5A. The idler stepped gear 403 meshes with the drum gears 402Y and 402M. The idler stepped gear 404 meshes with the drum gears 402C and 402K. The idler gear 405 meshes with the idler gear 406 and the idler stepped gear 403, and the idler gear 407 meshes with the idler gear 406 and the idler stepped gear 404. The attachment gear 412M is integrated with the drum gear 402M. The attachment gear 412K is integrated with the drum gear 402K.

FIG. 4B is a diagram illustrating the driving stabilization unit. Note that the driving stabilization unit G1 and the driving stabilization units G2 and G3 employ the same configuration.

The driving stabilization units G1, G2, and G3 may each include a first adjustment gear 413, a second adjustment gear 414, and a torsion coil spring 415. A first arm of the torsion coil spring 415 is held by a spring hook portion 413a of the first adjustment gear 413, and a second arm of the torsion coil spring 415 is held by a spring hook portion 414a of the second adjustment gear 414. A relationship between the first adjustment gear 413, the second adjustment gear 414, and the torsion coil spring 415 is the same as the relationship between the first adjustment gear 204, the second adjustment gear 205, and the spring 206 in the driving stabilization unit G according to Embodiment 1. That is, the torsion coil spring 415 biases one of the first adjustment gear 413 and the second adjustment gear 414 in a first rotation direction, and biases the other of the first adjustment gear 413 and the second adjustment gear 414 in a second rotation direction opposite to the first rotation direction.

The first adjustment gear 413 and the second adjustment gear 414 rotate about a predetermined rotation axis at the same rotational speed. Since the configurations of the driving stabilization units G1, G2, and G3 are the same as the configuration of the driving stabilization unit G according to Embodiment 1, detailed description thereof will be omitted.

A drive portion that rotates the transfer belt 14 includes a driver roller gear 408 and idler gears 409, 410, and 411. The driver roller gear 408 is disposed coaxially with the driver roller 15 and drives the driver roller 15. The idler gears 409, 410, and 411 are configured to transmit a driving force from the motor 400 to the driver roller gear 408.

A driving state during image formation will be described with reference to FIGS. 6A and 6B.

As drawn with solid lines in FIG. 6A, a drive train forming a closed loop including the idler stepped gear 403, the drum gear 402Y, the driving stabilization unit G1, the drum gear 402M, and the attachment gear 412M is formed. In a relationship illustrated in FIG. 6A, the drum gear 402Y is an example of the first transmission member, and a member (gear) formed by integrating the drum gear 402M and the attachment gear 412M is an example of the second transmission member. The first adjustment gear 413 is an example of the third transmission member, and engages (meshes) with the first transmission member and is apart from the second transmission member. The second adjustment gear 414 is an example of the fourth transmission member, and engages (meshes) with the second transmission member and is apart from the first transmission member. The second adjustment gear 414 meshes with the attachment gear 412M. The idler stepped gear 403 is an example of a connection portion (intermediate transmission portion) connected to the first transmission member and the second transmission member. The idler stepped gear 403 is also an example of the output transmission member. The magnitude relationship between the spring force of the torsion coil spring 415, the rotation load of the photosensitive drum 2, and the force received by the photosensitive drum 2 from the transfer belt 14 is the same as that in Embodiment 1.

In FIGS. 5B, 6A, and FIG. 6B, a mark 601 denotes a portion at which a spring force acts from one gear to the other gear, and the one gear contacts the downstream side tooth surface of the other gear (the tooth surface directed to the downstream side in the rotation direction of the other gear). A mark 602 denotes a portion at which the spring force acts from the one gear to the other gear, and the one gear contacts the upstream side tooth surface of the other gear (the tooth surface directed to the upstream side in the rotation direction of the other gear). The drum gear 402Y receives a spring force in middle dotted line arrow direction in FIG. 6A from the first adjustment gear 413. On the other hand, the drum gear 402M receives a spring force in the middle dotted line arrow direction in FIG. 6A from the second adjustment gear 414 via the attachment gear 412M. Hence, even when the force received by the photosensitive drum fluctuates, contact between the drum gear 402Y and the idler stepped gear 403 is maintained, and contact between the drum gear 402M and the idler stepped gear 403 is maintained.

The idler stepped gear 403, the drum gear 402Y, the driving stabilization unit G1, the drum gear 402M, and the attachment gear 412M are driven according to the speed of the motor 400.

It can be said that a relationship between the idler stepped gear 403, the drum gear 402Y, the driving stabilization unit G1, the drum gear 402M, and the attachment gear 412M is the same as the relationship with the drum drive portion according to Embodiment 1.

As drawn with solid lines in FIG. 6B, a drive train forming a closed loop including the idler gear 406, the idler gear 405, the idler stepped gear 403, the drum gear 402M, the attachment gear 412M, the driving stabilization unit G2, the drum gear 402C, the idler stepped gear 404, and the idler gear 407 is formed. In the relationship illustrated in FIG. 6B, a member (gear) formed by integrating the drum gear 402M and the attachment gear 412M is an example of the first transmission member, and the drum gear 402C is an example of the second transmission member. The second adjustment gear 414 is an example of the third transmission member, and engages (meshes) with the first transmission member and is apart from the second transmission member. The second adjustment gear 414 meshes with the attachment gear 412M. The first adjustment gear 413 is an example of the fourth transmission member, and engages (meshes) with the second transmission member and is apart from the first transmission member. The idler gear 406, the idler gear 405, the idler stepped gear 403, the idler stepped gear 404, and the idler gear 407 are examples of the connection portions (intermediate transmission portions) connected to the first transmission member and the second transmission member. The idler gear 406 is an example of the output transmission member.

The relationship between the spring force of the torsion coil spring 415, the rotation load of the photosensitive drum 2, and the force received by the photosensitive drum 2 from the transfer belt 14 is the same as that described in Embodiment 1. The drum gear 402C receives a spring force in a middle dotted line arrow direction in FIG. 6B from the first adjustment gear 413. The spring force is greater than a force received by the photosensitive drums 2C from the transfer belt 14. Hence, the drum gear 402C rotates without moving apart from the idler stepped gear 404. On the other hand, the drum gear 402M receives a spring force in the middle dotted line arrow direction in FIG. 6A from the second adjustment gear 414 via the attachment gear 412M. The spring force is greater than the rotation load of the photosensitive drum 2M. Hence, the drum gear 402M rotates without moving apart from the idler stepped gear 403.

The spring force also acts between the idler gear 406, the idler gear 405, the idler stepped gear 403, the idler stepped gear 404, and the idler gear 407. Accordingly, the meshing state of the gears is maintained.

The idler gear 406, the idler gear 405, the idler stepped gear 403, the drum gear 402M, the attachment gear 412M, the driving stabilization unit G2, the drum gear 402C, the idler stepped gear 404, and the idler gear 407 are driven according to the speed of the motor 400. It can be said that a relationship between the idler gear 406, the idler gear 405, the idler stepped gear 403, the drum gear 402M, the attachment gear 412M, the driving stabilization unit G2, the drum gear 402C, the idler stepped gear 404, and the idler gear 407 is the same as the relationship with the drum drive portion according to Embodiment 1.

Since the driving stabilization unit G3 is the same as the driving stabilization unit G1, the description thereof will be omitted.

Note that a rotation load of the driver roller 15 acts on the idler gear 406. As a result, a state where the idler gear 406 is in contact with the downstream side tooth surface of the pinion gear 401 (the tooth surface directed to the downstream side in the rotation direction of the pinion gear 401) is maintained. The rotation load of the idler gear 406 increases due to the rotation load of the driver roller 15. Accordingly, when the photosensitive drum 2 receives the force in the leading rotation direction from the transfer belt 14, the rotation load of the idler gear 406 is higher than the force acting on the idler gear 406. Accordingly, the idler gear 406 does not move apart from the pinion gear 401.

FIG. 5B is a diagram illustrating the rotation direction of each gear and a direction of a torque received by each gear. A solid line arrow direction indicates the rotation direction, and a dotted line arrow direction indicates the direction of the torque received by each gear. As illustrated in FIG. 5B, each gear stably contacts the upstream side tooth surface or the downstream side tooth surface of the other gear. As a result, it is possible to rotate each gear and each photosensitive drum at a constant speed that complies with the speed of the motor 400.

As described above, even the configuration where the one motor rotates the four photosensitive drums and the transfer belt can suppress rotational fluctuation of the photosensitive drums 2 as compared with Embodiment 1.

As described in the present embodiment, the drive train according to the present disclosure may include a plurality of drive trains forming closed loops.

### Embodiment 3

Embodiment 3 will describe a case where a configuration according to the present disclosure is employed for a monochromatic laser printer that uses only one photosensitive drum. Hence, description of portions that overlap those in Embodiment 1 will be omitted.

### Overall Schematic View

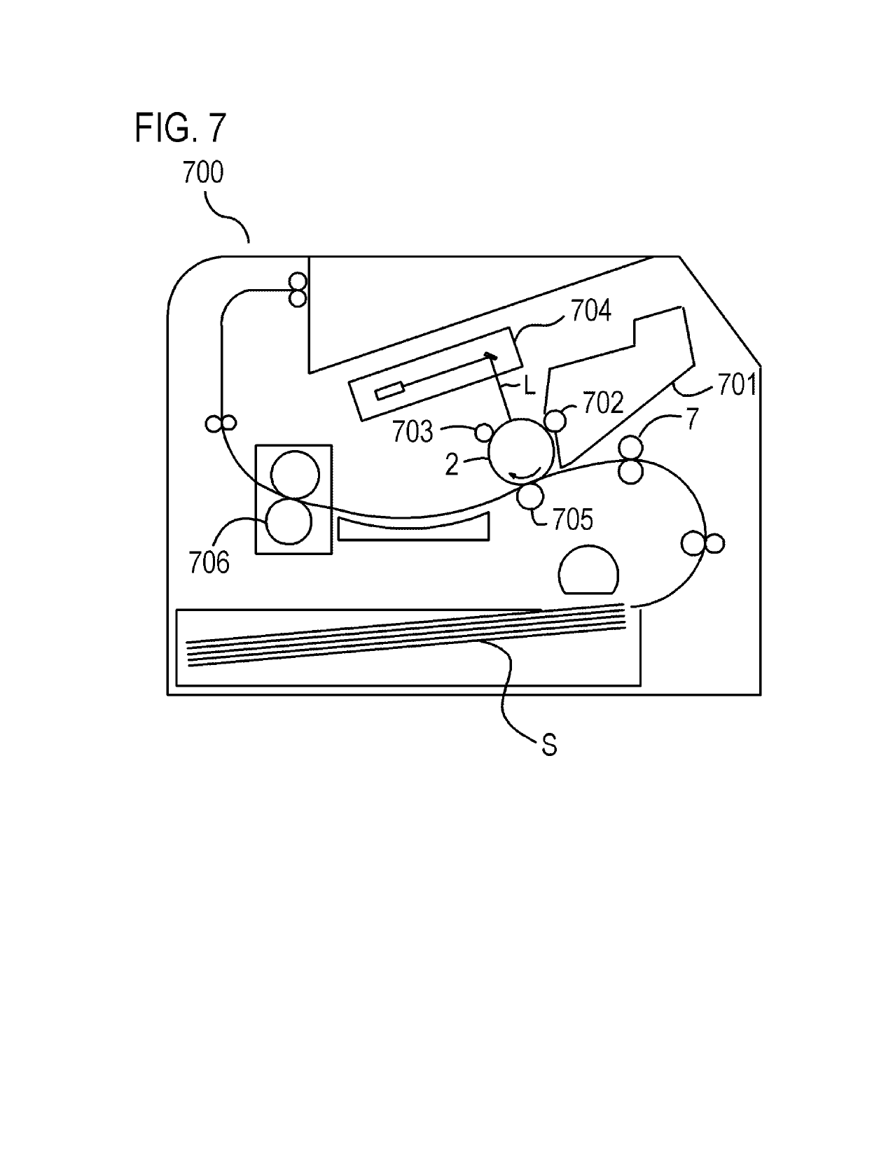

FIG. 7 is a cross-sectional view of an image forming apparatus 700 according to Embodiment 3. As an example of the image forming apparatus, the monochromatic laser beam printer that uses an electrophotographic process will be described. Since a paper feeding portion, a fixing portion, and a paper discharge portion employ the same configurations as those of the color laser beam printer according to Embodiment 1, detailed description thereof will be omitted.

The image forming apparatus 700 includes a process cartridge 701 that is attachable to and detachable from an apparatus main body.

The image forming portion is provided with a charging roller 703 that uniformly charges the surface of the photosensitive drum 2, and a developing roller 702 that supplies toner to an electrostatic latent image formed on the photosensitive drum 2, and develops the electrostatic latent image as a toner image. A laser scanner 704 is disposed as an exposure unit above the photosensitive drum 2. The image forming apparatus includes a transfer roller 705 that transfers the toner image from the photosensitive drum 2 to the recording material S and a pair of fixing rollers 706 that fix the toner onto the recording material S. This process cartridge 701 is provided with the developing roller 702. Note that the process cartridge 701 may include the photosensitive drum 2 and the charging roller 703, and may further include the transfer roller 705.

The image forming process will be described. The photosensitive drum 2 is driven at a predetermined rotation speed in a clockwise direction in FIG. 7. The charging roller 703 uniformly charges the surface of the photosensitive drum 2 that rotates. The laser scanner 704 emits the laser beam L corresponding to image information to expose the surface of the photosensitive drum 2. Thus, an electrostatic latent image corresponding to the image information is formed on the surface of the photosensitive drum 2. This electrostatic latent image is developed as a toner image by the developing roller 702. Furthermore, this toner image is transferred by the transfer roller 705 onto the recording material S conveyed to a nip portion between the photosensitive drum 2 and the transfer roller 705. The recording material S onto which the toner image has been transferred is conveyed to the pair of fixing rollers 706. The toner image on the recording material S is heated and pressurized by the pair of fixing rollers 706, and thereby is fixed onto the recording material S. The developer remaining on the photosensitive drum 2 is collected by the developing roller 702.

Also in the present embodiment, a cleaning member such as the cleaning blade is not in contact with the photosensitive drum 2, so that rotation load torques of the photosensitive drums 2 are low. Hence, for example, thermal expansion of the pair of fixing rollers 706 increases a conveying speed of the recording material S, pulls the recording material S nipped between the photosensitive drum 2 and the transfer roller 705, and causes leading rotation of the photosensitive drums 2.

### Drive Configuration

The drum drive portion will be described in detail.

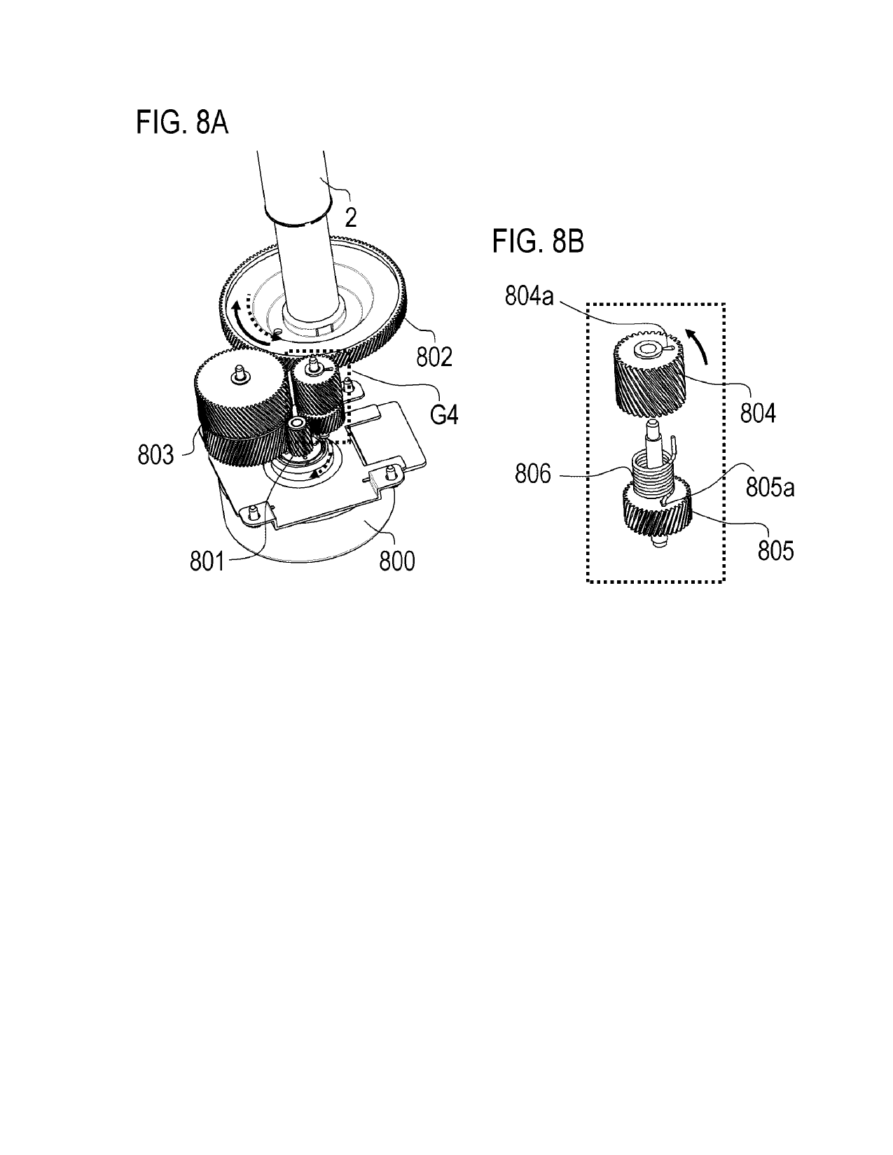

FIGS. 8A and 8B are diagrams illustrating a drive train according to the present embodiment. FIG. 8A is a perspective view of the drum drive portion, and illustrates a drive transmission portion from a motor 800 to the photosensitive drum 2. Furthermore, FIG. 8B is a part diagram illustrating the inside of a driving stabilization unit G4 in FIG. 8A.

The drum drive portion according to the present embodiment includes the motor 800, a pinion gear 801, a drum gear 802, an idler stepped gear 803, and the driving stabilization unit G4. The motor 800 is a driving source that generates a driving force for driving the photosensitive drum 2. The pinion gear 801 is fixed to the shaft of the motor 800 by indentation. The drum gear 802 is connected to the photosensitive drum 2 and rotates the photosensitive drum 2 in an arrow direction in FIG. 8A. The drum gear 802 employs the same configuration as those of the drum gear 201C and the like in Embodiment 1. The idler stepped gear 803 meshes with the pinion gear 801 and the drum gear 802.

A configuration of the driving stabilization unit G4 will be described with reference to FIG. 8B.

The driving stabilization unit G4 includes a first adjustment gear 804, a second adjustment gear 805, and a torsion coil spring 806. A first arm of the torsion coil spring 806 is held by a spring hook portion 804a of the first adjustment gear 804, and a second arm of the torsion coil spring 806 is held by a spring hook portion 805a of the second adjustment gear 805. A relationship between the first adjustment gear 804, the second adjustment gear 805, and the torsion coil spring 806 is the same as the relationship between the first adjustment gear 204, the second adjustment gear 205, and the torsion coil spring 206 in the driving stabilization unit G according to Embodiment 1. That is, the torsion coil spring 806 biases one of the first adjustment gear 804 and the second adjustment gear 805 in the first rotation direction, and biases the other of the first adjustment gear 804 and the second adjustment gear 805 in the second rotation direction opposite to the first rotation direction.

As described above, a drive train forming a closed loop including the pinion gear 801, the drum gear 802, the idler stepped gear 803, and the driving stabilization unit G4 is formed. The drum gear 802 is an example of the first transmission member, and the pinion gear 801 is an example of the second transmission member. The first adjustment gear 804 is an example of the third transmission member, and meshes with the drum gear 802 and is apart from the pinion gear 801. The second adjustment gear 805 is an example of the fourth transmission member, and meshes with the pinion gear 801 and is apart from the drum gear 802. The idler stepped gear 803 is an example of a connection portion (intermediate transmission portion) connected to the drum gear 802 and the pinion gear 801 to form the drive train forming the closed loop. The pinion gear 801 is an example of the output transmission member.

Furthermore, the first adjustment gear 804 and the second adjustment gear 805 rotate about the predetermined rotation axis in a solid line rotation direction in FIG. 8B at the same rotational speed. Consequently, it is possible to keep a spring pressure of the torsion coil spring 806 substantially constantly even during rotation. Since the configuration of the driving stabilization unit G4 is the same configuration as that of the driving stabilization unit according to Embodiment 1, detailed description thereof will be omitted.

The configuration according to the present embodiment also maintains a contact state between the pinion gear 801, the idler stepped gear 803, the drum gear 802, the first adjustment gear 804, and the second adjustment gear 805 by the spring force. As a result, the photosensitive drum 2 can stably rotate.

As described above, even in the case of the one photosensitive drum, the photosensitive drum can rotate at a constant speed without causing any leading rotation.

Furthermore, it is not necessary to use a member such as a flywheel that increases a rotation load in the configuration according to the present embodiment, either.

### Embodiment 4

Embodiment 4 will be described. Embodiment 4 will describe a configuration of releasing biasing of a biasing member in a driving stabilization unit. Embodiment 4 will be described as a modified example of Embodiment 2, yet can be also combined with Embodiment 1 or Embodiment 3.

When, for example, a drive train including a driving stabilization unit is left in a high-temperature environment for a long time, a biasing force of a biasing member deforms at least one of the first transmission member, the second transmission member, the third transmission member, and the fourth transmission member, and rotation accuracy of these members may lower.

For example, it is conceivable that, when the image forming apparatus is transported, the image forming apparatus is left in a high-temperature environment for a long time. In the present embodiment, when the image forming apparatus is unused, biasing of the biasing member in the driving stabilization unit is released. As a result, when, for example, the image forming apparatus is transported, deformation of the first transmission member, the second transmission member, the third transmission member, and the fourth transmission member is suppressed.

When the image forming apparatus is used, the biasing member biases the third transmission member and the fourth transmission member. As a result, the image forming operation for a recording material is performed in a state where the biasing member biases the third transmission member and the fourth transmission member.

Since the present embodiment differs from Embodiment 2 only in the configuration of the driving stabilization unit and the other portions employ the same configurations, the configuration and an operation of the driving stabilization unit will be mainly described.

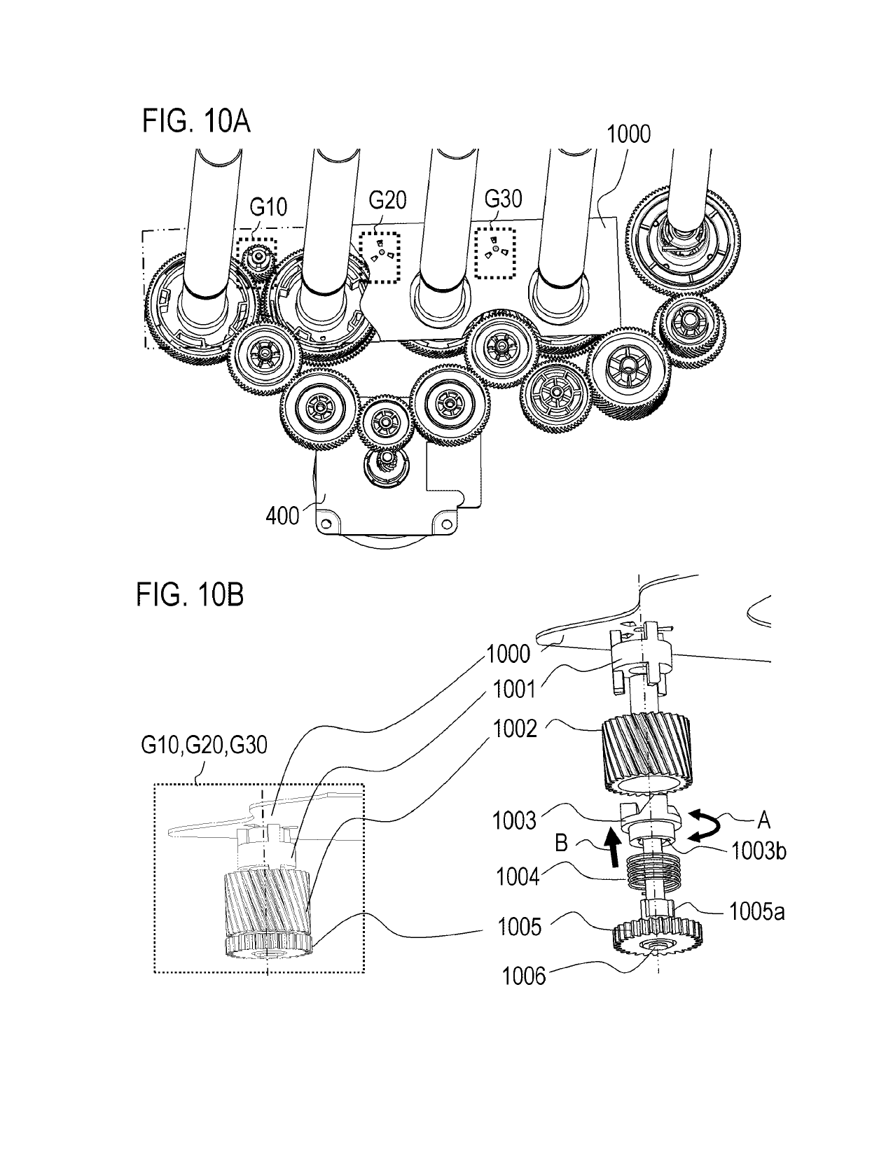

FIGS. 10A and 10B are diagrams illustrating a drive train according to the present embodiment. FIG. 10A is a diagram illustrating the drive train including driving stabilization units (G10, G20, and G30) according to the present embodiment. Configurations of the driving stabilization units G10, G20, and G30 are the same.

The left side of FIG. 10B is a perspective view of the driving stabilization units G10, G20, and G30.

The right side of FIG. 10B is an exploded view of the driving stabilization units G10, G20, and G30. As described above, the configurations of the driving stabilization units G10, G20, and G30 are the same. Accordingly, these driving stabilization units will not be distinguished from each other in the following description, and will be referred to simply as a driving stabilization unit.

As illustrated in FIG. 10B, the driving stabilization unit includes a first adjustment gear 1002 as the third transmission member, a compression spring 1004, and a second adjustment gear 1005 as the fourth transmission member. Furthermore, the driving stabilization unit includes a force applying cam 1003 and a releasing cam 1001 as a releasing unit (releasing member), and includes a shaft 1006 that supports the first adjustment gear 1002, the force applying cam 1003, and the second adjustment gear 1005. In the present embodiment, materials of the first adjustment gear 1002, a drum gear meshing with the first adjustment gear 1002, the second adjustment gear 1005, and a drum gear meshing with the second adjustment gear 1005 are resin. A depressed portion 1003b of the force applying cam 1003 engages with a protruded portion 1005a of the second adjustment gear 1005. Relative movement of the force applying cam 1003 and the second adjustment gear 1005 in the rotation direction (an arrow A direction in FIG. 10B) is limited. On the other hand, the force applying cam 1003 and the second adjustment gear 1005 can perform relative movement in a rotation axis direction (in an arrow B direction in FIG. 10B) of the second adjustment gear 1005. As described later, the compression spring 1004 and the force applying cam 1003 function as biasing members that bias one of the third transmission member and the fourth transmission member in the first rotation direction, and bias the other of the third transmission member and the fourth transmission member in the second rotation direction opposite to the first rotation direction. Similarly to Embodiment 2, the first adjustment gear 1002 and the second adjustment gear 1005 mesh with respectively different drum gears. When the image forming apparatus is left in a high-temperature environment for a long time, deformation of the first adjustment gear 1002 and deformation of the drum gear meshing with the first adjustment gear 1002 may occur and, moreover, deformation of the second adjustment gear 1005 and deformation of the drum gear meshing with the second adjustment gear 1005 may occur. The first adjustment gear 1002 and the second adjustment gear 1005 have the same rotational speed.

### Description of Operation

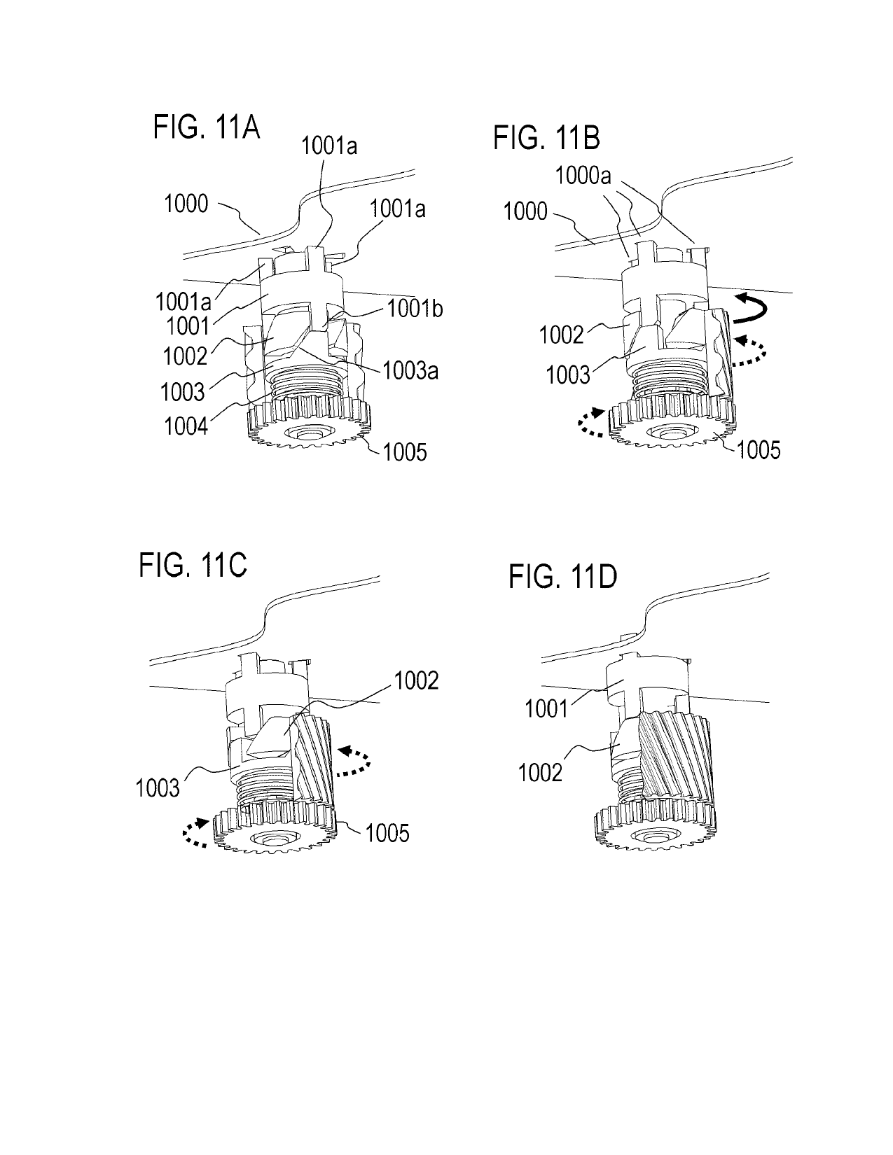

Next, an operation of the driving stabilization unit will be described with reference to FIGS. 11A to 11D. FIGS. 11A to 11D are diagrams illustrating the operation of the drive train according to the present embodiment. FIG. 11A illustrates a state where the releasing cam 1001 is apart from the first adjustment gear 1002. FIG. 11B illustrates a state where the releasing cam 1001 has rotated from a position in FIG. 11A. FIG. 11C illustrates a retracting operation of the releasing cam 1001. FIG. 11D illustrates a retracted state of the releasing cam 1001. Note that illustration of part of the first adjustment gear 1002 is not omitted for the sake of description in FIGS. 11A to 11D.

In the rotation axis direction of the second adjustment gear 1005, one end of the releasing cam 1001 includes side plate abutting portions 1001a, and the other end of the releasing cam 1001 includes a cam pressing portion 1001b. As illustrated in FIG. 11A, the side plate abutting portion 1001a of the releasing cam 1001 abuts a driving side plate 1000. Although the releasing cam 1001 includes the three side plate abutting portions 1001a in the present embodiment, the number of the side plate abutting portions 1001a may be one or may be two. Furthermore, the number of the side plate abutting portions 1001a may be more than three. The cam pressing portion 1001b abuts the force applying cam 1003 to press the force applying cam 1003. As will be described later, the biasing force of the compression spring 1004 is applied to the first adjustment gear 1002 via the force applying cam 1003. On the other hand, in a state illustrated in FIG. 11A, a gap 1003a is formed between the force applying cam 1003 and the first adjustment gear 1002, and the biasing force of the compression spring 1004 does not transmit to the first adjustment gear 1002. That is, the state is a released state where the biasing force of the compression spring 1004 to be applied to the first adjustment gear 1002 has been released. As a result, deformation of the first adjustment gear 1002 and deformation of the drum gear meshing with the first adjustment gear 1002 are suppressed. Furthermore, deformation of the second adjustment gear 1005 and deformation of the drum gear meshing with the second adjustment gear 1005 are also suppressed.

At a time of use of the image forming apparatus, when the image forming apparatus is powered on, the motor 400 is driven. As a result, the first adjustment gear 1002 and the second adjustment gear 1005 rotate. On the other hand, the driving side plate 1000 includes releasing cam retraction holes 1000a. The number of the releasing cam retraction holes 1000a is the same as the number of the side plate abutting portions 1001a. When the releasing cam 1001 rotates together with the second adjustment gear 1005 and the force applying cam 1003, the side plate abutting portions 1001a match with the releasing cam retraction holes 1000a.

The side plate abutting portions 1001a of the releasing cam 1001 are inserted into the releasing cam retraction holes 1000a by the force of the compression spring 1004. At this time, the releasing cam 1001 stops rotating. On the other hand, the force applying cam 1003 that has been pushed by the releasing cam 1001 moves so as to cover the gap 1003a, and contacts the first adjustment gear 1002. That is, the released state where the biasing force of the biasing member is released transitions to a biased state where the biasing force is applied.

The biasing force of the compression spring 1004 acts in the rotation axis direction of the second adjustment gear 1005 and the first adjustment gear 1002. Furthermore, the force applying cam 1003 includes an inclined surface that contacts the first adjustment gear 1002. In the present embodiment, the first adjustment gear 1002 also includes an inclined surface that contacts the inclined surface of the force applying cam 1003. Relative movement of the force applying cam 1003 and the second adjustment gear 1005 in the rotation direction is limited. When the force applying cam 1003 is biased by the compression spring 1004, and the inclined surfaces of the force applying cam 1003 and the first adjustment gear 1002 contact each other, the force of the compression spring 1004 acts in the rotation direction of the first adjustment gear 1002 via the force applying cam 1003. Furthermore, when the force applying cam 1003 receives a reaction force, the second adjustment gear 1005 is biased in a direction opposite to that of the first adjustment gear 1002. As a result, the first adjustment gear 1002 and the second adjustment gear 1005 receive forces in opposite directions as indicated by dotted line arrow directions in FIGS. 11B and 11C. As a result, the driving stabilization unit can achieve driving stabilization.

Furthermore, when the first adjustment gear 1002 and the second adjustment gear 1005 rotate, the releasing cam 1001 moves toward the driving side plate 1000 and moves to such a position that the releasing cam 1001 does not interfere with rotation of the first adjustment gear 1002 as illustrated in FIG. 11D. In the present embodiment, the first adjustment gear 1002 includes the inclined surface that causes the releasing cam 1001 to move toward the driving side plate 1000. However, there may be employed a configuration where, for example, a spring biases the releasing cam 1001 toward the driving side plate 1000, and the releasing cam 1001 retracts when the side plate abutting portions 1001a match with the releasing cam retraction holes 1000a.

As described above, the force applying cam 1003 functions as a transmission portion that transmits to the first adjustment gear 1002 the force of the compression spring 1004 that is a biasing portion. The force applying cam 1003 can move to a transmission position at which the force of the compression spring 1004 transmits to the first adjustment gear 1002, and a blocking position (FIG. 11A) at which transmission of the force of the compression spring 1004 to the first adjustment gear 1002 is blocked. When the force applying cam 1003 is at the transmission position, biasing members (the compression spring 1004 and the force applying cam 1003) bias one of the third transmission member and the fourth transmission member in the first rotation direction, and bias the other of the third transmission member and the fourth transmission member in the second rotation direction opposite to the first rotation direction. The releasing cam 1001 can move to a holding position at which the force applying cam 1003 is held at the blocking position, and an allowable position at which the force applying cam 1003 is allowed to be located at the transmission position. According to the configuration according to the present embodiment, deformation of the driving stabilization unit and the gears meshing with the third transmission member and the fourth transmission member of the driving stabilization unit is suppressed.

### Embodiment 5

Embodiment 5 will be described. Embodiment 5 will describe a configuration of releasing biasing of a biasing member in a driving stabilization unit. Embodiment 5 will be described as a modified example of Embodiment 2, yet can be also combined with Embodiment 1 or Embodiment 3.

In Embodiment 4, when the image forming apparatus is unused, biasing of the biasing member in the driving stabilization unit is released, and, when the image forming apparatus is used, the biasing member biases the third transmission member and the fourth transmission member. However, to further suppress deformation of the driving stabilization unit and the gears meshing with the third transmission member and the fourth transmission member of the driving stabilization unit, a biasing force is applied only during image formation and the biasing force is released after image formation ends.

Hence, in the present embodiment, the biasing force of the driving stabilization unit is released by backward rotation of the motor 400. Consequently, the biasing force of the driving stabilization unit is applied at the time of image formation, and biasing of the driving stabilization unit is released after image formation is performed (after image formation ends).

### Description of Configuration

Since the configuration according to the present embodiment differs from that of Embodiment 2 in configurations of driving stabilization units and drum gears, and the other portions employ the same configurations, the configurations and operations of the driving stabilization units and the drum gears will be mainly described.

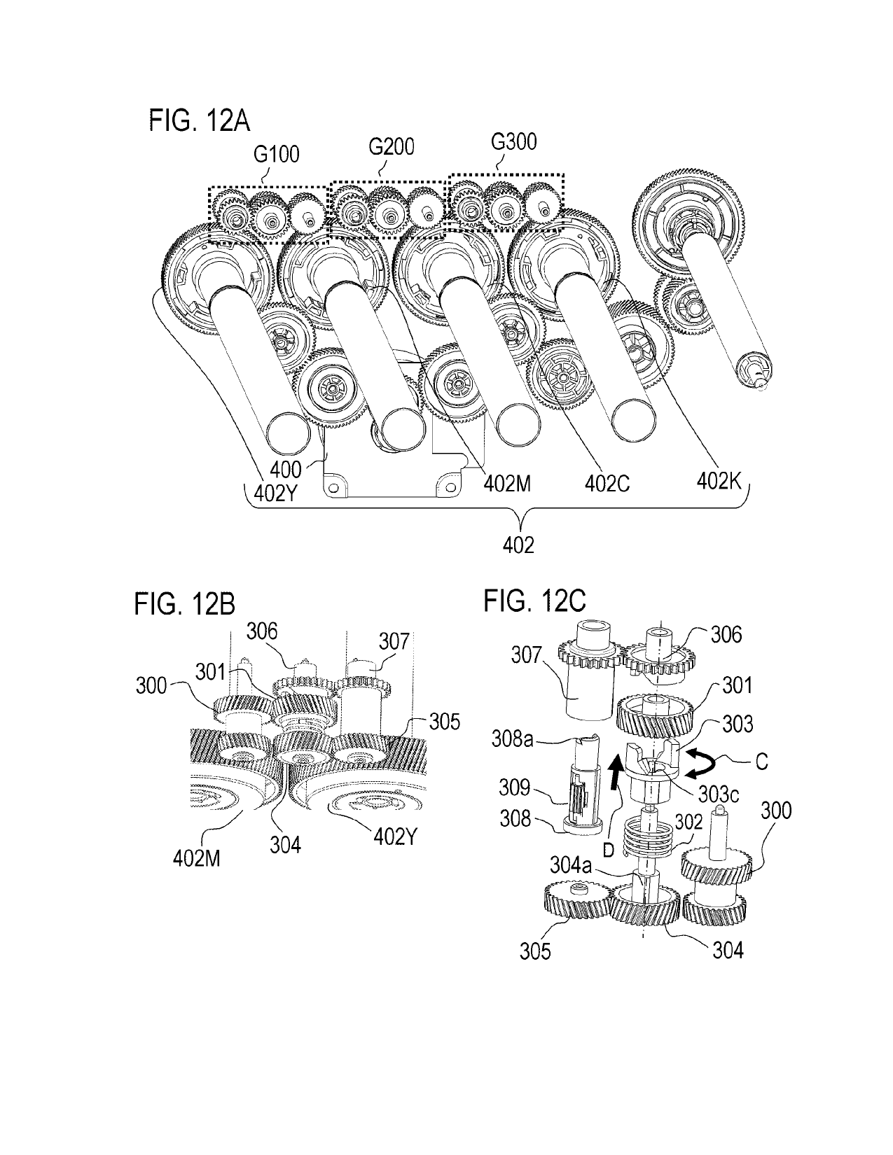

FIGS. 12A, 12B, and 12C are diagrams illustrating a drive train according to the present embodiment. FIG. 12A is a diagram illustrating the drive train including driving stabilization units (G100, G200, and G300) in the present embodiment. Configurations of the driving stabilization units G100, G200, and G300 are the same.

FIG. 12B is a perspective view of the driving stabilization unit G100. FIG. 12B is drawn from such a viewpoint that the photosensitive drum 2 is located at the upper side in the figure. FIG. 12C is an exploded view of the driving stabilization unit G100.

As described above, the configurations of the driving stabilization units G100, G200, and G300 are the same. Accordingly, the following description will be given using the driving stabilization unit G100.

The driving stabilization unit G100 includes an upper force applying gear 301 as the third transmission member, a lower force applying gear 304 as the fourth transmission member, a compression spring 302 as the biasing portion, and a force applying cam 303 as the transmission portion. Furthermore, the driving stabilization unit G100 includes a releasing cam gear 306 as a releasing unit (releasing member), a one-way gear 307, an idler gear 305, and a stepped gear 300. In the present embodiment, materials of the upper force applying gear 301, the lower force applying gear 304, the idler gear 305, the stepped gear 300, the drum gear 402Y, and the drum gear 402M are resin. The compression spring 302 and the force applying cam 303 function as biasing members that bias one of the third transmission member and the fourth transmission member in the first rotation direction, and bias the other of the third transmission member and the fourth transmission member in the second rotation direction opposite to the first rotation direction. The idler gear 305 meshes with the drum gear 402Y and the lower force applying gear 304 to transmit the driving force of the motor 400 to the lower force applying gear 304.

The force applying cam 303 receives a force in a rotation axis direction (an arrow D direction in FIG. 12C) of the lower force applying gear 304 from the compression spring 302. The force applying cam 303 is configured to apply the force in the rotation direction to the upper force applying gear 301.

The force applying cam 303 includes a depressed portion 303c, and the lower force applying gear 304 includes a protruded portion 304a. The depressed portion 303c and the protruded portion 304a engage with each other to limit relative movement of the force applying cam 303 and the lower force applying gear 304 in the rotation direction (an arrow C direction in FIG. 12C). On the other hand, the force applying cam 303 and the lower force applying gear 304 can perform relative movement in the rotation axis direction (an arrow B direction in FIG. 12C) of the lower force applying gear 304. The stepped gear 300 meshes with the upper force applying gear 301 and the drum gear 402M. Although described in detail later, the stepped gear 300 transmits the force of the compression spring 302 to the drum gear 402M.

Note that the lower force applying gear 304 and the upper force applying gear 301 have the same rotational speed.

The releasing cam gear 306 pushes down the force applying cam 303. As a result, inclined surfaces of the force applying cam 303 and the upper force applying gear 301 move apart from each other, and the force applying cam 303 does not transmit the biasing force of the compression spring 302 to the upper force applying gear 301 in this state.

The one-way gear 307 meshes with the releasing cam gear 306, rotates at the time of image formation (when the motor 400 rotates forward), and does not rotate when the motor 400 rotates backward.

More specifically, a support shaft 308 supports the one-way gear 307, and a rotation stopper 308a is inserted into a frame of the image forming apparatus to limit movement in the rotation direction.

A one-way mechanism gear 309 is disposed inside the support shaft 308 and engages with the one-way gear 307. The one-way mechanism gear 309 allows the one-way gear 307 to rotate with respect to the support shaft 308 when the motor 400 rotates forward. On the other hand, the one-way mechanism gear 309 limits the one-way gear 307 from rotating with respect to the support shaft 308 when the motor 400 rotates backward.

Note that a mechanism that allows rotation of the one-way gear 307 when the motor 400 rotates forward, and limits rotation of the one-way gear 307 when the motor 400 rotates backward is not limited to the above configuration. Although detailed description of the configuration of the one-way mechanism gear 309 will be omitted, various configurations can be used as a configuration that allows or limits rotation of the one-way gear 307.

### Description of Operation

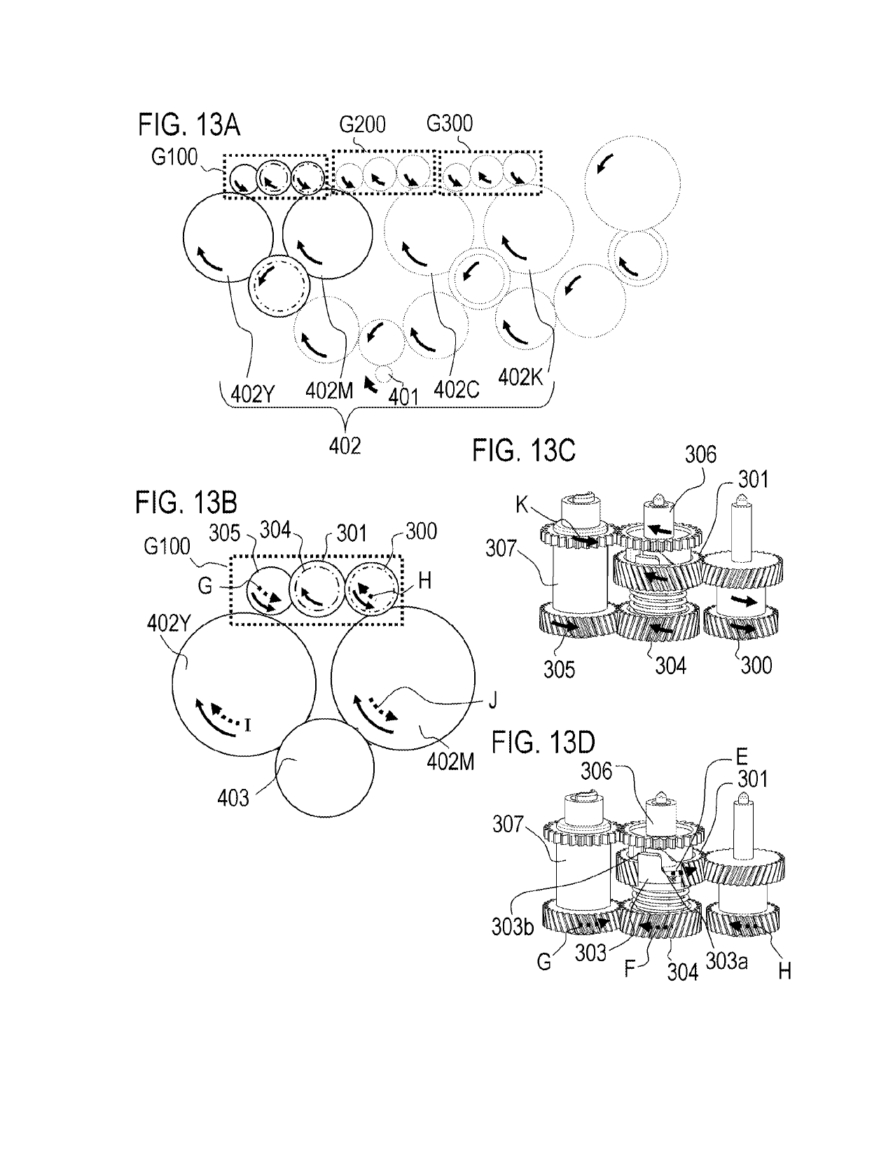

First, an operation of image formation, that is, an operation of the driving stabilization unit G100 at the time at which the motor 400 rotates forward will be described. FIGS. 13A, 13B, 13C, and FIG. 13D are diagrams illustrating the operation of the drive train at the time at which the motor 400 rotates forward.

When the motor 400 rotates forward as illustrated in FIG. 13A, the pinion gear 401 rotates clockwise in FIG. 13A. Note that, as illustrated in FIG. 13A, a relationship between the driving stabilization unit G100, the drum gear 402Y, and the drum gear 402M is the same as a relationship between the driving stabilization unit G200, the drum gear 402M, and the drum gear 402C. Furthermore, a relationship between the driving stabilization unit G200, the drum gear 402M, and the drum gear 402C is the same as a relationship between the driving stabilization unit G300, the drum gear 402C, and the drum gear 402K.

FIG. 13B is an enlarged view of the driving stabilization unit G100 and the drum gears 402Y and 402M. Dotted line arrows in FIG. 13B indicate the directions of forces received by the respective gears. The solid line arrows in FIG. 13B indicate the rotation directions of the respective gears.

FIG. 13C is a perspective view of the driving stabilization unit G100. Solid line arrows in FIG. 13C indicate the rotation directions of the respective gears.

FIG. 13D is a perspective view of the driving stabilization unit G100. For the sake of description, illustration of part of the upper force applying gear 301 will be omitted. Dotted line arrows in FIG. 13D indicate the directions of the forces received by the respective gears.

As described above, the drum gear 402Y and the idler gear 305 mesh with each other, and the idler gear 305 and the lower force applying gear 304 mesh with each other. Furthermore, the drum gear 402M and the stepped gear 300 mesh with each other, and the stepped gear 300 and the upper force applying gear 301 mesh with each other.

The drum gear 402Y and the drum gear 402M rotate in the same direction and at the same rotational speed. Furthermore, the upper force applying gear 301 and the lower force applying gear 304 also rotate in the same direction and at the same circumferential speed. As a result, relative rotation of the force applying cam 303 and the upper force applying gear 301 is suppressed.

The biasing force of the compression spring 302 acts in a rotation axis direction of the lower force applying gear 304 and the upper force applying gear 301. The force applying cam 303 includes an inclined surface 303a that contacts the upper force applying gear 301. Furthermore, as described above, relative movement of the force applying cam 303 and the lower force applying gear 304 in the rotation direction is limited. When the force applying cam 303 is biased by the compression spring 302 and the inclined surface 303a of the force applying cam 303 contacts the upper force applying gear 301, the force of the compression spring 302 acts in the rotation direction of the upper force applying gear 301 via the force applying cam 303. Furthermore, when the force applying cam 303 receives a reaction force, the lower force applying gear 304 is biased in a direction opposite to that of the upper force applying gear 301. As a result, the upper force applying gear 301 and the lower force applying gear 304 receive forces in mutually opposite directions from the compression spring 302. That is, as illustrated in FIG. 13D, the upper force applying gear 301 receives a force in a dotted line arrow E direction, and the lower force applying gear 304 receives a force in a dotted line arrow F direction. As a result, as illustrated in FIGS. 13B and 13D, the idler gear 305 receives a force in a dotted line arrow G direction, and the stepped gear 300 receives a force in a dotted line arrow H direction. Furthermore, the drum gear 402Y receives a force in a dotted line arrow I direction, and the drum gear 402M receives a force in a dotted line arrow J direction. As a result, the driving stabilization unit G100 stabilizes driving.

On the other hand, as illustrated in FIG. 13D, the force applying cam 303 pushes the releasing cam gear 306 in the rotation direction using a rib 303b. The releasing cam gear 306 meshes with the one-way gear 307. When the motor 400 rotates forward, the one-way gear 307 is allowed to rotate in a solid line arrow K direction in FIG. 13C. Accordingly, each of the force applying cam 303, the releasing cam gear 306, and the one-way gear 307 can rotate.

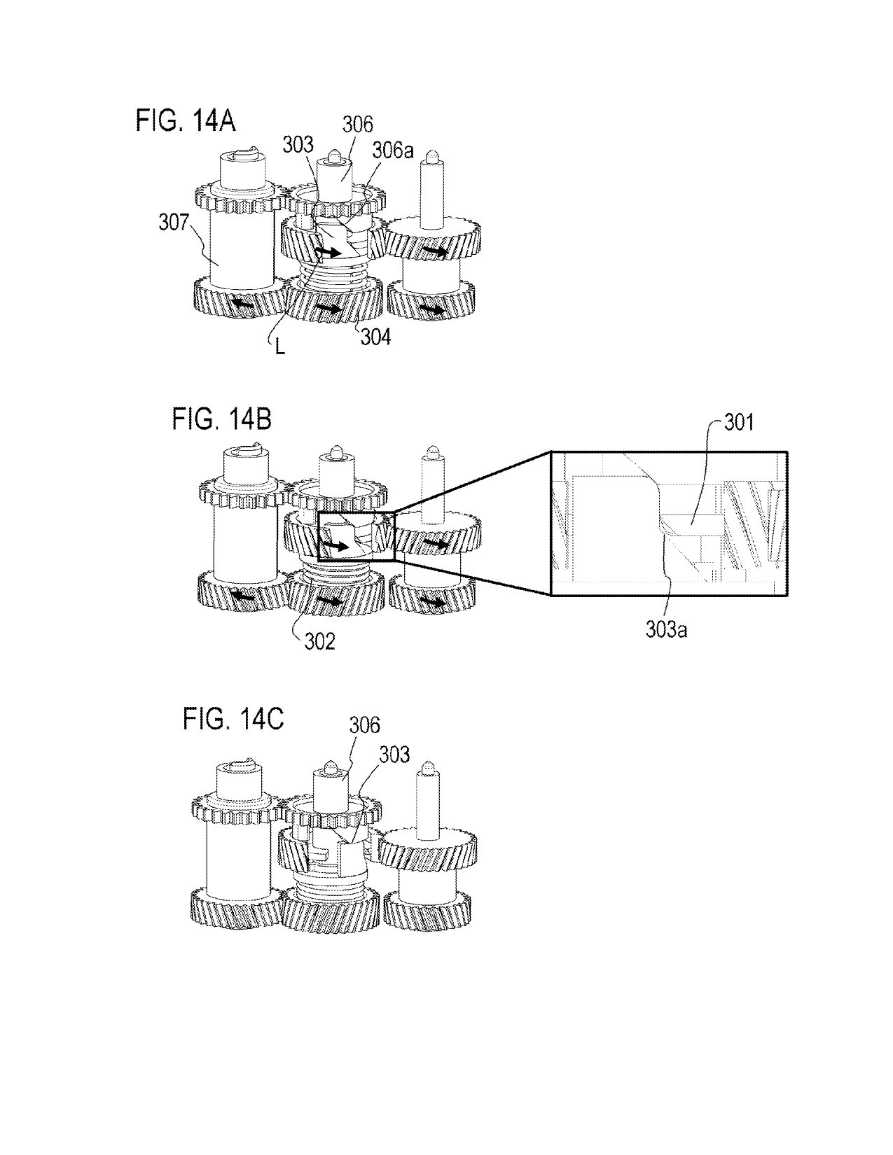

Next, the operation of the driving stabilization unit G100 at a time at which the motor 400 rotates backward will be described. FIGS. 14A, 14B, and 14C are diagrams illustrating an operation of the drive train at the time at which the motor 400 rotates backward. When the motor 400 rotates backward, the driving stabilization unit G100 can transition to a state where the force of the compression spring 302 is not applied to the drum gear 402Y and the drum gear 402M. FIGS. 14A, 14B, and FIG. 14C are diagrams for describing the operation of the driving stabilization unit G100 at the time at which the motor 400 rotates backward. When the motor 400 starts backward rotation, the force applying cam 303 transitions in order of FIGS. 14A, 14B, and FIG. 14C.

Relative movement of the force applying cam 303 and the lower force applying gear 304 in the rotation direction is limited. When the motor 400 rotates backward, the force applying cam 303 rotates in an arrow L direction in FIG. 14A in conjunction with rotation of the lower force applying gear 304.

The force applying cam 303 contacts an inclined surface part 306a of the releasing cam gear 306. On the other hand, as described above, rotation of the one-way gear 307 meshing with the releasing cam gear 306 is limited, and the releasing cam gear 306 does not rotate. In a state where the releasing cam gear 306 stops, the force applying cam 303 receives a reaction force from the inclined surface part 306a of the releasing cam gear 306. Furthermore, the force applying cam 303 is pushed to compress the compression spring 302. As a result, a gap is formed between the inclined surface 303a provided to the force applying cam 303 and the upper force applying gear 301, so that the force of the compression spring 302 is not transmitted to the upper force applying gear 301. As a result, deformation of the upper force applying gear 301, the lower force applying gear 304, the idler gear 305, the stepped gear 300, the drum gear 402Y, and the drum gear 402M is suppressed. In the present embodiment, when the motor 400 further rotates backward, the force applying cam 303 gets on the releasing cam gear 306 as illustrated in FIG. 14C.

As described above, the force applying cam 303 functions as a transmission portion that transmits to the upper force applying gear 301 the force of the compression spring 302 that is the biasing portion. The force applying cam 303 can move to a transmission position at which the force of the compression spring 302 transmits to the upper force applying gear 301, and a blocking position at which transmission of the force of the compression spring 302 to the upper force applying gear 301 is blocked. When the force applying cam 303 is at the transmission position, biasing members (the compression spring 302 and the force applying cam 303) bias one of the third transmission member and the fourth transmission member in the first rotation direction, and bias the other of the third transmission member and the fourth transmission member in the second rotation direction opposite to the first rotation direction. The releasing cam gear 306 is configured to move the force applying cam 303 from the transmission position to the blocking position. In the present embodiment, before the image forming apparatus is used, the driving stabilization unit G100 takes the blocking position (FIG. 14C). On the other hand, when the image forming operation is performed on a recording material, the motor 400 rotates forward, and the force applying cam 303 is located at the transmission position, and, after the image forming operation is performed, the motor 400 rotates backward, and the force applying cam 303 is located at the blocking position.

### Modified Example

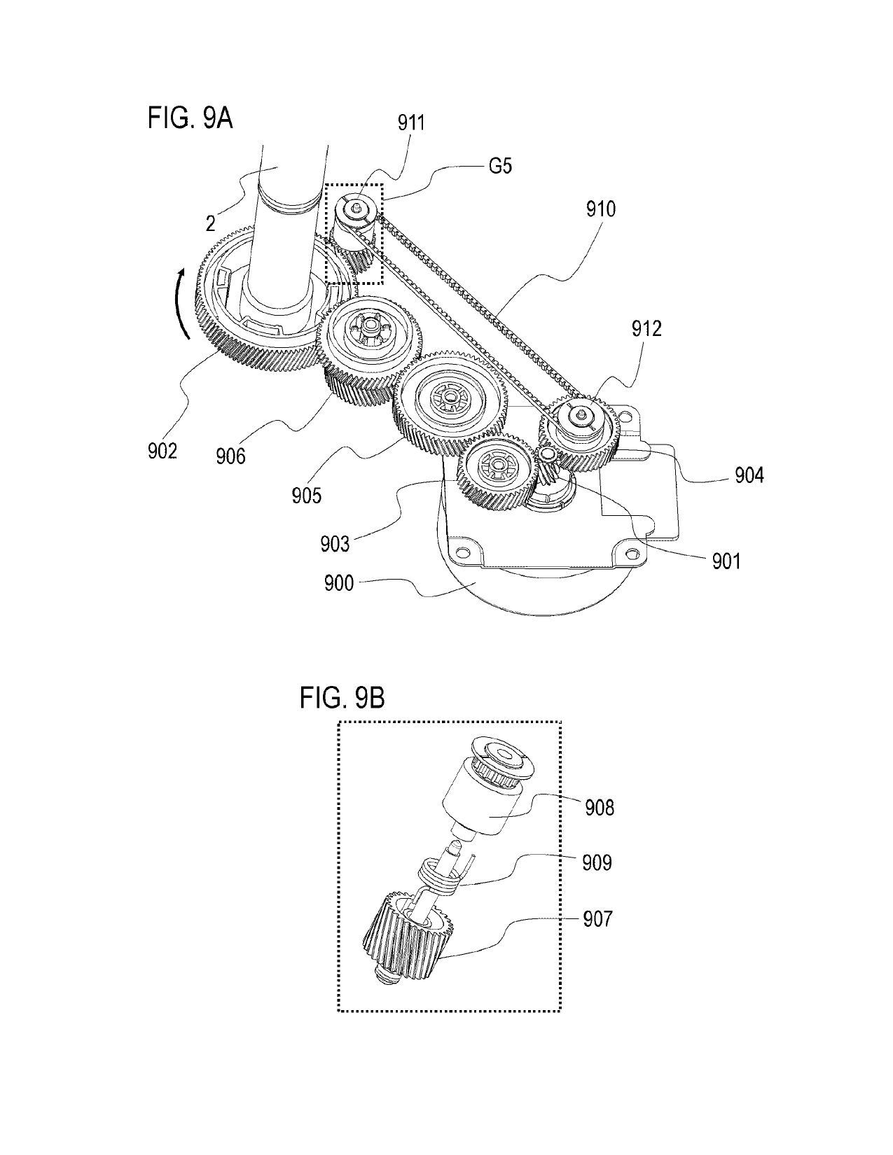

FIGS. 9A and 9B are diagrams illustrating a drive train according to a modified example. FIG. 9A is a perspective view of a drum drive portion according to the modified example of the embodiment of the present disclosure, and illustrates a drive transmission portion from a motor 900 to the photosensitive drum 2. Furthermore, FIG. 9B is a part diagram illustrating the inside of the driving stabilization unit G5 in FIG. 9A. Matters that are not described here in the present modified example is the same as those of the above embodiments, and detailed description thereof will be omitted.

The drum drive portion according to the present modified example includes the motor 900, a pinion gear 901, a drum gear 902, idler gears 903, 904, and 905, an idler stepped gear 906, and a driving stabilization unit G5. The drum drive portion according to the present modified example further includes a first pulley 911, a second pulley 912, and a timing belt 910. The idler gear 904 includes a second pulley 912.

The motor 900 generates a driving force for driving the photosensitive drum 2. The pinion gear 901 is fixed to the shaft of the motor 900 by indentation. The drum gear 902 is connected with the photosensitive drum 2, and employs the same configuration as those of the drum gear 201C and the like in Embodiment 1. The drum gear 902 rotates the photosensitive drum 2 in an arrow direction in FIG. 9A.

A configuration of the driving stabilization unit G5 will be described with reference to FIG. 9B.

The driving stabilization unit G5 includes a first adjustment gear 907, a second adjustment rotary shaft 908, and a torsion coil spring 909. The driving stabilization unit G5 employs the same configuration as those of the driving stabilization units G1 to G4 described in the previous embodiments. The second adjustment rotary shaft 908 includes the first pulley 911.

In the present modified example, the drum gear 902 is an example of the first transmission member, and the timing belt 910 is an example of the second transmission member. The first adjustment gear 907 is an example of the third transmission member, and meshes with the drum gear 902 and is apart from the timing belt 910. The second adjustment rotary shaft 908 is an example of the fourth transmission member, and the first pulley 911 meshes with the timing belt 910 and is apart from the drum gear 902. The idler stepped gear 906, the idler gears 905 and 903, the pinion gear 901, and the idler gear 904 are examples of the connection portions (intermediate transmission portions) connected to the drum gear 902 and the timing belt 910. The pinion gear 901 is an example of the output transmission member. As illustrated in FIG. 9A, a drive train including the pinion gear 901, the idler gears 903 and 905, the idler stepped gear 906, the drum gear 902, the driving stabilization unit G5, the timing belt 910,. and the idler gear 904 is formed.

Although the drive train includes the plurality of gears in the configurations according to Embodiments 1 to 5, the drive train may include the timing belt as in the present modified example. Although the timing belt 910 functions as the second transmission member in the present modified example, the timing belt may be used as the first transmission member or the connection portion. That is, the drive train may include at least one gear or may include at least one timing belt. Also in the configuration according to the present modified example, contact between the transmission members in the drive train is maintained by the spring force of the torsion coil spring 909. The configuration according to the present modified example can also obtain the same effect as those of the above embodiments.

In each of the above embodiments, the respective configurations can be combined. Furthermore, the drive train according to each embodiment is a drive train for driving the photosensitive drums, yet can be used as drive trains of various rotating members such as a developing roller, a conveyance roller for the recording material S, and a driver roller for the transfer belt. Furthermore, for example, the drive train may be configured to drive the photosensitive drum as the first rotating member and a driver roller for the transfer belt as the second rotating member.

According to the present disclosure, it is possible to provide a configuration that can suppress fluctuation of a rotation speed in a drive train.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Applications No. 2024-224518, filed on December 19, 2024, and No. 2025-166441, filed on October 2, 2025, which are hereby incorporated by reference herein in their entirety.

What is claimed is:

1. An image forming apparatus comprising:
a first transmission member;
a second transmission member;
a third transmission member configured to rotate about a rotation axis in a first rotation direction, the third transmission member configured to engage with the first transmission member and being apart from the second transmission member;
a fourth transmission member configured to rotate about the rotation axis in the first rotation direction, the fourth transmission member configured to engage with the second transmission member and being apart from the first transmission member;
a biasing member connected to the third transmission member and the fourth transmission member, and the biasing member configured to bias one of the third transmission member and the fourth transmission member in the first rotation direction and to bias an other of the third transmission member and the fourth transmission member in a second rotation direction opposite to the first rotation direction; and
a connection portion that is connected to the first transmission member and the second transmission member to form a drive train forming a closed loop, the closed loop including the first transmission member, the second transmission member, the third transmission member, the biasing member, and the fourth transmission member, wherein
a rotational speed of the third transmission member is the same as a rotational speed of the fourth transmission member.

2. The image forming apparatus according to claim 1, wherein
the third transmission member and the fourth transmission member are coaxially disposed.

3. The image forming apparatus according to claim 1, wherein
the first transmission member includes a plurality of first teeth,
the second transmission member includes a plurality of second teeth,
the third transmission member includes a plurality of third teeth that mesh with the plurality of first teeth, and
the fourth transmission member includes a plurality of fourth teeth that mesh with the plurality of second teeth.

4. The image forming apparatus according to claim 3, wherein
the number of teeth of the plurality of third teeth and the number of teeth of the plurality of fourth teeth are the same, and
the number of teeth of the plurality of first teeth and the number of teeth of the plurality of second teeth are the same.

5. The image forming apparatus according to claim 1, wherein
the drive train includes at least one gear.

6. The image forming apparatus according to claim 1, wherein
the drive train includes at least one timing belt.

7. The image forming apparatus according to claim 1, wherein
the third transmission member includes a first coupling configured to engage with a first rotating member and configured to transmit a driving force to the first rotating member.

8. The image forming apparatus according to claim 7, wherein
the first rotating member is a photosensitive drum.

9. The image forming apparatus according to claim 7, wherein
the first rotating member is a driver roller configured to rotate a transfer belt.

10. The image forming apparatus according to claim 7, wherein
the fourth transmission member includes a second coupling configured to engage with a second rotating member and configured to transmit a driving force to the second rotating member.

11. The image forming apparatus according to claim 10, wherein
the first rotating member is a first photosensitive drum, and
the second rotating member is a second photosensitive drum.

12. The image forming apparatus according to claim 10, wherein
the first rotating member is a photosensitive drum, and
the second rotating member is a driver roller configured to rotate a transfer belt.

13. The image forming apparatus according to claim 1, further comprising a driving source, wherein
the drive train includes an output transmission member configured to be driven by the driving source.

14. The image forming apparatus according to claim 1, further comprising a releasing unit configured to release application of a biasing force from the biasing member to at least one of the third transmission member and the fourth transmission member.

15. The image forming apparatus according to claim 14, wherein
the releasing unit is configured to transition from a released state to a biased state before image formation is performed, the released state being a state where the application of the biasing force to at least one of the third transmission member and the fourth transmission member is released, and the biased state being a state where the biasing force is applied to at least one of the third transmission member and the fourth transmission member.

16. The image forming apparatus according to claim 15, wherein
the releasing unit is configured to transition to the released state again after the image formation is performed.
